(19) United States
(12) Patent Application Publication
(10) Pub. No.: US 2009/0097274 A1
(43) Pub. Date: Apr. 16, 2009

(54) DIFFUSER PLATE AND SURFACE LIGHT SOURCE APPARATUS

(75) Inventors: Masayuki Shinohara, Kyoto (JP); Yasuhiro Tanoue, Kyoto (JP); Yoshihiro Ueno, Kyoto (JP); Kazuhide Hirota, Kyoto (JP); Tetsuya Minobe, Kyoto (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi, Kyoto (JP)

(21) Appl. No.: 12/295,822

(22) PCT Filed: Apr. 19, 2007
(86) PCT No.: PCT/JP2007/058510

§ 371 Date: Oct. 2, 2008

(30) Foreign Application Priority Data
Apr. 19, 2006 (JP) 2006-116232

(51) Int. Cl. G02B 5/02; F21V 8/00

(52) U.S. Cl. 362/619; 359/599

(57) ABSTRACT

On a light guide plate (32), a prism sheet (36), an uneven diffuser plate (37) and a correcting optical sheet (38) are placed one over another. Light outputted from the light guide plate (32) in a direction substantially parallel to a light outputting surface (45) is bent to a direction substantially vertical to the light outputting surface (45) by the prism sheet (36). Light which passed through the prism sheet (36) and has a long directivity characteristic in an r axis direction is converted into light having a substantially circular directivity characteristic by passing through the uneven diffuser plate (37). Furthermore, the light which passed through the uneven diffuser plate (37) and has the substantially circular directivity characteristic is converted into light having a directivity characteristic closer to a perfect circle by the correcting optical sheet (38). The correcting optical sheet (38) is formed of a pattern having many polyhedron shapes.

### TECHNICAL FIELD

The present invention relates to a diffuser plate and a surface light source apparatus. In particular, the present invention relates to a surface light source apparatus used as a backlight and the like for illuminating liquid crystal display panel, and a diffuser plate for diffusing light radiated from a light guide plate of the surface light source apparatus.

### BACKGROUND ART

FIG. 1 is an exploded perspective view showing a structure of a surface light source apparatus 11 (Patent Document 1) of a first prior art example. FIG. 2 is a schematic cross-sectional view thereof. The surface light source apparatus 11 mainly includes a light guide plate 12, a light emission unit 13, a reflecting plate 14, and a diffuser prism sheet 15. In the description of the prior art example, a z axis is defined in a direction perpendicular to the surface of the light guide plate 12, and an x axis and a y axis are respectively defined in directions parallel to two sides of the light guide plate 12 adjacent to a position corresponding to the light emission unit 13. Furthermore, an r axis is defined in a direction passing through the light emission unit 13 parallel to the surface of the light guide plate 12 within a plane perpendicular to the light guide plate 12, and a θ axis is defined in a direction orthogonal to the z axis and the r axis.

The light guide plate 12 is formed to a square flat plate shape from transparent resin such as polycarbonate resin and methacrylic resin, where a light incident surface 17 is formed at a corner of the light guide plate 12. Great number of deflection patterns 16 is formed on a lower surface of the light guide plate 12. The deflection patterns 16 are concentrically arrayed with the light emission unit 13 as a center, where each deflection pattern 16 is formed by having the back surface of the light guide plate 12 to a concave shape with a V-groove shape of a triangular cross-section.

The light emission unit 13 has a small light emission element such as an LED sealed therein. The reflecting plate 14 has the surface subjected to mirror-like finishing by Ag plating, and is arranged to face the entire back surface of the light guide plate 12.

The diffuser prism sheet 15 has a transparent uneven diffuser plate 19 formed on the surface of a transparent plastic sheet 18, and a transparent prism sheet 20 formed on the back surface of the plastic sheet 18. With a conical concave part having an obtuse vertex randomly lined substantially without a gap as a unit, the uneven diffuser plate 19 has the concave part repeatedly arrayed vertically and horizontally at a predetermined pitch. The prism sheet 20 has an arcuate prism 21, which cross-section is a left-right asymmetric triangle, concentrically arrayed, where each arcuate prism 21 is formed to an arcuate shape with the light emission unit 13 as the center.

As shown in FIG. 2, in such surface light source apparatus 11, light p output from the light emission unit 13 enters the light guide plate 12 from the light incident surface 17. The light p entered into the light guide plate 12 from the light incident surface 17 radially advances through the light guide plate 12 while repeating total reflection with the upper surface and the lower surface of the light guide plate 12. The light p entering the lower surface of the light guide plate 12 has the angle of incidence to the upper surface (light outputting surface 22) of the light guide plate 12 becoming smaller with the reflection by the deflection pattern 16 having a triangular cross-section, and the light p entered into a light outputting surface 22 at an angle of incidence smaller than a critical angle of total reflection is output from the light guide plate 12 towards a direction substantially parallel to the light outputting surface 22. The light p output in a direction substantially parallel to the light outputting surface 22 is passed through the prism sheet 20 to be bent in a direction substantially perpendicular to the light outputting surface 22, and then diffused by the uneven diffuser plate 19 so that directivity is extended.

In this surface light source apparatus 11, all the deflection patterns 16 are arranged so as to be orthogonal to a direction connecting the light emission unit 13 and each deflection pattern 16, and thus even if the light p propagating through the light guide plate 12 is diffused by the deflection pattern 16, such light p is diffused within a plane (zr plane) perpendicular to the light guide plate 12 including the direction connecting the light emission unit 13 and the deflection pattern 16, but linearly advances without being deflected within a plane (xy plane) of the light guide plate 12. As a result, the directivity characteristic of the light output from the light outputting surface 22 of the light guide plate 12, passed through the diffuser prism sheet 15, and bent in a direction perpendicular to the light outputting surface 22 is wide in the r axis direction and extremely narrow in the θ direction, as shown in FIG. 3. FIG. 3 shows the directivity characteristic at each point on the diffuser prism sheet 15, which directivity characteristic represents the light intensity in each direction when seen from a constant angle with respect to the direction perpendicular to the diffuser prism sheet 15 as a distance from the center of the plane of drawing.

As shown in FIG. 3, when the surface light source apparatus 11 is seen from a certain direction, light of large light intensity as shown with an arrow in FIG. 3 reaches the observer at point A positioned in a direction connecting the observer and the light emission unit 13, but only light of small light intensity reaches the observer as shown with arrows in FIG. 3 at points B, C deviated from the direction connecting the observer and the light emission unit 13. Thus, when the surface light source apparatus 11 is seen from an oblique direction, a bright line 23 appears in the direction of the light emission unit 13 thereby lowering the visibility of the surface light source apparatus 11, as shown in FIG. 4.

The cause of generation of such bright line is the uneven directivity characteristic in each direction. That is, as shown in FIG. 5, if the directivity characteristic at each point is even in each direction and represented with a circle, the light intensity reaching the observer will be the same at all the points when the surface light source apparatus 11 is observed from a certain direction. The bright line and the luminance unevenness will not occur in the surface light source apparatus.

The inventors of the present invention thus proposed a diffuser prism sheet 15 having a combined pattern in which a plurality of first uneven patterns that is linearly long in one direction and a plurality of second uneven patterns of concave lens shape arrayed at random are combined on the surface side (Patent Document 2). According to the surface light source apparatus of a second prior art example including such diffuser prism sheet 15, the directivity characteristic becomes substantially circular, and the bright line of the surface light source apparatus is barely significant.

However, even in such surface light source apparatus, the directivity characteristic of each point is slightly distorted from a circle in microscopic view as shown in FIG. 6, and the shape differs by places. Thus, the bright line still remains even in such improved surface light source apparatus.

Recently, with higher definition of the liquid crystal display including the surface light source apparatus as a backlight and higher level of required performance of the surface light source apparatus, even minimal bright lines and luminance unevenness are considered as a problem, and thus even such minimal bright lines need to be resolved.

Patent Document 1: Japanese Laid-Open Patent Publication No. 2003-215584

Patent Document 2: Japanese Laid-Open Patent Publication No. 2005-352400

### DISCLOSURE OF THE INVENTION

### Problems to be Solved by the Invention

In view of the above problems, the present invention aims to provide a diffuser plate capable of further reducing bright lines and luminance unevenness, and a surface light source apparatus equipped with the diffuser plate.

### Means for Solving the Problems

A diffuser plate according to the present invention has an optical pattern with discrete diffusion characteristic formed on one of the surfaces of a substrate where light enters from one surface and the light exits from the other surface.

In the diffuser plate of the present invention, the optical pattern has discrete diffusion characteristics, and thus the diffusion characteristic in each direction can be independently designed when designing the optical pattern, and the desired diffusion characteristic can be easily obtained. Thus, for example, when the surface light source apparatus is used, the pattern shape can be controlled at satisfactory precision so as to resolve the bright lines and the luminance unevenness.

One aspect of the diffuser plate according to the present invention has features in that the diffusion characteristic differs depending on positions on the substrate. Thus, according to the relevant aspect, the diffusion characteristic can be individually adjusted at each position of the substrate, the difference in directivity characteristic at each position of the light entering the diffuser plate can be corrected, and the directivity characteristic of the light passed through the diffuser plate can be evened.

The optical pattern in another aspect of the diffuser plate according to the present invention is formed by a polyhedron for diffusing the light in discrete directions. Therefore, the diffusion characteristic of the optical pattern, that is, the diffusing direction and the light intensity of the light can be easily adjusted by adjusting the orientation, the tilt, and the area of each plane of the polyhedron, and the diffusion characteristic at each position of the diffuser plate can be accurately controlled.

In the aspects described above, each polyhedron has a shape defined to diffuse the light in one or more diffusing directions of a plurality of main diffusing directions extracted from a predetermined diffusion characteristic. If a plurality of polyhedrons having shapes defined to diffuse the light in one or more diffusing directions of the plurality of main diffusing directions extracted from the predetermined diffusion characteristic (general-purpose diffusion characteristic) is designed, the necessary diffusion characteristic can be easily realized with the entire diffuser plate by adjusting one of the plurality of polyhedrons or a combination of each polyhedron, the distribution ratio of each polyhedron etc. at each position of the diffuser plate.

Each type of optical pattern according to still another aspect of the diffuser plate according to the present invention has a feature in that a pattern density is changed depending on the position on the substrate. According to such aspect, the directivity characteristic can be adjusted by the pattern density, whereby the type of patterns of the diffuser plate can be reduced and designing and manufacturing of the diffuser plate can be facilitated.

Yet another aspect of the diffuser plate according to the present invention has a feature in that a prism is formed on the other surface of the substrate. According to such aspect, the directivity characteristic of the light can be adjusted by the pattern after changing the direction of the incident light with the prism.

Yet another aspect of the present invention relates to the diffuser plate of the present invention arranged on a light outputting surface side of a light guide plate arranged with a light source facing an end face; wherein a concave optical pattern is arranged at a position corresponding to immediately in front of the light source. According to such aspect, the bright lines generated in the diagonal direction at immediately in front of the light source can be suppressed.

A surface light source apparatus according to the present invention includes a light source; a light guide plate for outputting light introduced from the light source from the light outputting surface while being spread to a surface form; and the diffuser plate arranged facing the light outputting surface of the light guide plate. According to the surface light source apparatus of the present invention, the directivity characteristic of the light transmitted through the substrate can be evened with the entire substrate.

The components described above of the present invention can be arbitrarily combined to a maximum extent.

### BRIEF DESCRIPTION OF THE DRAWINGS

FIG. 1 is an exploded perspective view showing a structure of a surface light source apparatus according to a first prior art example.

FIG. 2 is a schematic cross-sectional view of the first prior art example.

FIG. 3 is a view describing directivity characteristic of light output from the surface light source apparatus according to the first prior art example.

FIG. 4 is a perspective view showing a state in which bright lines are generated in the surface light source apparatus according to the first prior art example.

FIG. 5 is a view showing a preferred directivity characteristic of the surface light source apparatus.

FIG. 6 is a view showing a directivity characteristic according to a second prior art example.

FIG. 7 is an exploded perspective view showing a surface light source apparatus according to a first embodiment of the present invention.

FIG. 8 is a view showing an array of deflection patterns formed at a lower surface of a light guide plate in the surface light source apparatus of the first embodiment.

FIG. 9 is a perspective view of a prism sheet seen from the back surface side used in the surface light source apparatus of the first embodiment.

FIGS. 10(a) and (b) are views respectively showing a first uneven pattern and a second uneven pattern of an uneven diffuser plate used in the surface light source apparatus of the first embodiment, and FIG. 10(c) is a view showing a combined pattern of the uneven diffuser plate.

FIG. 11(a) is a perspective view describing an optical action of the first uneven pattern, and FIG. 11(b) is a perspective view describing an optical action of the second uneven pattern.

FIG. 12(a) is an enlarged view of the first uneven pattern 42, and FIG. 12(b) is an enlarged view of the second uneven pattern 43.

FIG. 13 is an enlarged view showing one part of the combined pattern of the uneven diffuser plate.

FIG. 14 is a view showing the uneven diffuser plate and the diffusion characteristic.

FIG. 15 is a view schematically showing the directivity characteristic of the light at each layer of the surface light source apparatus.

FIG. 16 is a view showing a directivity characteristic P1 of the light passed through the prism sheet and the uneven diffuser plate, a diffusion characteristic P2 of a correcting optical sheet, and a directivity characteristic P3 of a target perfect circle.

FIG. 17 is a plan view showing a correction pattern formed on the correcting optical sheet.

FIG. 18 is a view showing a typical diffusion characteristic P2 of the correcting optical sheet.

FIG. 19 is a plan view showing a correction pattern (46A) in contour line.

FIG. 20 is a plan view showing a correction pattern (46B) in contour line.

FIG. 21 is a plan view showing a correction pattern (46C) in contour line.

FIG. 22 is a plan view showing a correction pattern (46D) in contour line.

FIG. 23 is a plan view showing a correction pattern (46E) in contour line.

FIG. 24 is a perspective view of the correction pattern (46A).

FIG. 25(a) is a view showing a contour of the correction pattern (46A) seen from the front side and FIG. 25(b) is a view showing a contour of the correction pattern (46A) seen from the side surface side.

FIG. 26 is a perspective view of the correction pattern (46B).

FIG. 27(a) is a view showing a contour of the correction pattern (46B) seen from the front side and FIG. 27(b) is a view showing a contour of the correction pattern (46B) seen from the side surface side.

FIG. 28 is a perspective view of the correction pattern (46C).

FIG. 29(a) is a view showing a contour of the correction pattern (46C) seen from the front side and FIG. 29(b) is a view showing a contour of the correction pattern (46C) seen from the side surface side.

FIG. 30 is a perspective view of the correction pattern (46D).

FIG. 31(a) is a view showing a contour of the correction pattern (46D) seen from the front side and FIG. 31(b) is a view showing a contour of the correction pattern (46D) seen from the side surface side.

FIG. 32 is a perspective view of the correction pattern (46E).

FIG. 33(a) is a view showing a contour of the correction pattern (46E) seen from the front side and FIG. 33(b) is a view showing a contour of the correction pattern (46E) seen from the side surface side.

FIG. 34(a) is a schematic plan view schematically showing the main planes of the correction pattern shown in FIG. 21, and FIG. 34(b) is a view showing the diffusion characteristic of the light diffused by the relevant correction pattern.

FIG. 35 is a view showing the diffusion characteristic of the light diffused by the correction pattern shown in FIG. 19.

FIG. 36 is a view showing the diffusion characteristic of the light diffused by the correction pattern shown in FIG. 20.

FIG. 37 is a view showing the diffusion characteristic of the light diffused by the correction pattern shown in FIG. 21.

FIG. 38 is a view showing the diffusion characteristic of the light diffused by the correction pattern shown in FIG. 22.

FIG. 39 is a view showing the diffusion characteristic of the light diffused by the correction pattern shown in FIG. 23.

FIG. 40 is a view showing the diffusion characteristic combined by overlapping the diffusion characteristics of FIGS. 35 to 39.

FIG. 41 is a stereoscopic view of the diffusion characteristic of the light diffused with the correction pattern shown in FIG. 19.

FIG. 42 is a stereoscopic view of the diffusion characteristic of the light diffused with the correction pattern shown in FIG. 20.

FIG. 43 is a stereoscopic view of the diffusion characteristic of the light diffused with the correction pattern shown in FIG. 21.

FIG. 44 is a stereoscopic view of the diffusion characteristic of the light diffused with the correction pattern shown in FIG. 22.

FIG. 45 is a stereoscopic view of the diffusion characteristic of the light diffused with the correction pattern shown in FIG. 23.

FIG. 46 shows location dependability of the correction pattern.

FIG. 47 is a view showing a pattern density of the correction pattern (46A).

FIG. 48 is a view showing a pattern density of the correction pattern (46B).

FIG. 49 is a view showing a pattern density of the correction pattern (46C).

FIG. 50 is a view showing a pattern density of the correction pattern (46D).

FIG. 51 is a view showing a pattern density of the correction pattern (46E).

FIG. 52 is a view showing change in pattern density in the surface light source apparatus of each correction pattern.

FIG. 53 is a view showing the diffusion characteristic of the correcting optical sheet.

FIGS. 54(a) to (c) are views showing the diffusion characteristic P2 of the correcting optical sheet, and FIGS. 54(d) to (f) are views showing the directivity characteristic P3 of the light output through the correcting optical sheet.

FIG. 55 is an enlarged view of the diffuser plate.

FIGS. 56(a) to (c) are plan views and cross-sectional views showing other shapes of the correction pattern.

FIG. 57 is a perspective view showing another surface light source apparatus of the prior art.

FIG. 58(a) is a plan view showing a state of the surface light source apparatus of the prior art seen from above, FIG. 58(b) is a perspective view showing a state of the surface light source apparatus seen diagonally from the opposite side of the light source, and FIG. 58(c) is a perspective view showing a state of the surface light source apparatus seen diagonally from the light source side.

FIG. 59(a) shows a cross-section taken along line F-F of FIG. 58(b) and the directivity characteristic in the relevant direction, and FIG. 59(b) shows a cross-section taken along line G-G of FIG. 58(b) and the directivity characteristic in the relevant direction.

FIG. 60 is a plan view showing a surface light source apparatus according to a second embodiment of the present invention.

FIG. 61(a) is a plan view showing a diffusion pattern arranged on the surface light source apparatus, FIG. 61(b) is a cross-sectional view taken along line M-M of FIG. 61(a), and FIG. 61(c) is a cross-sectional view taken along line N-N of FIG. 61(a).

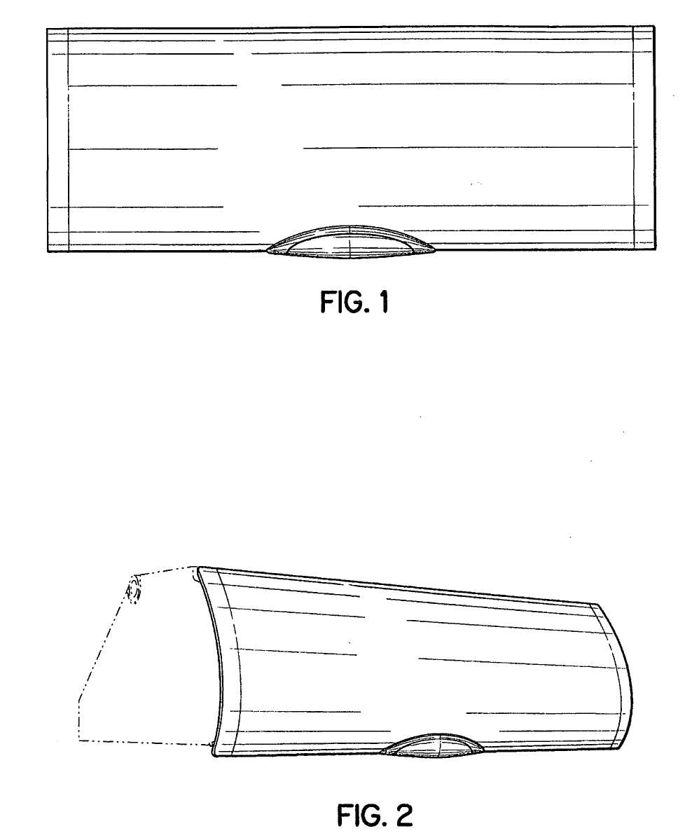

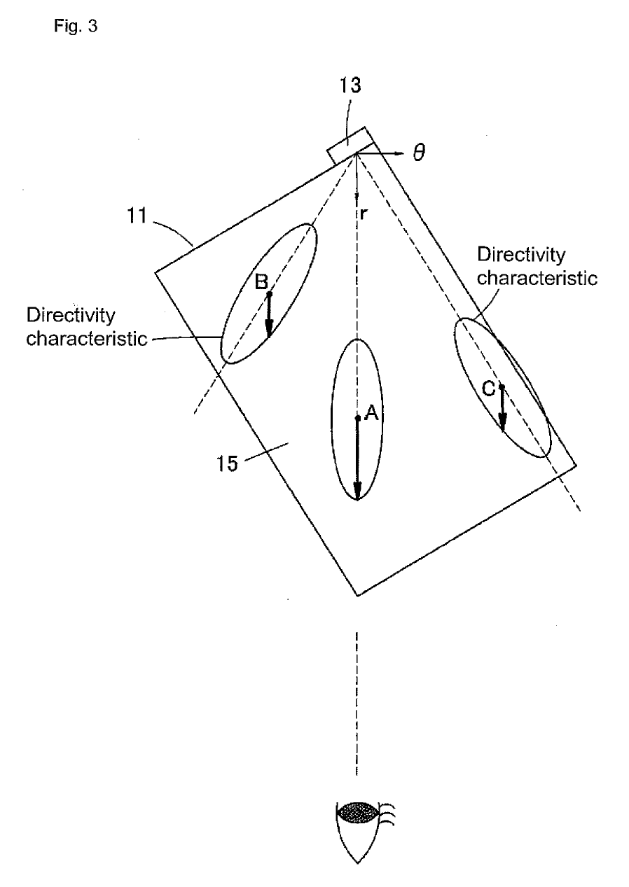

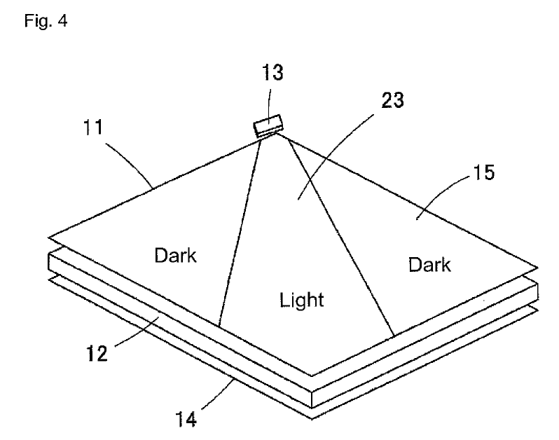

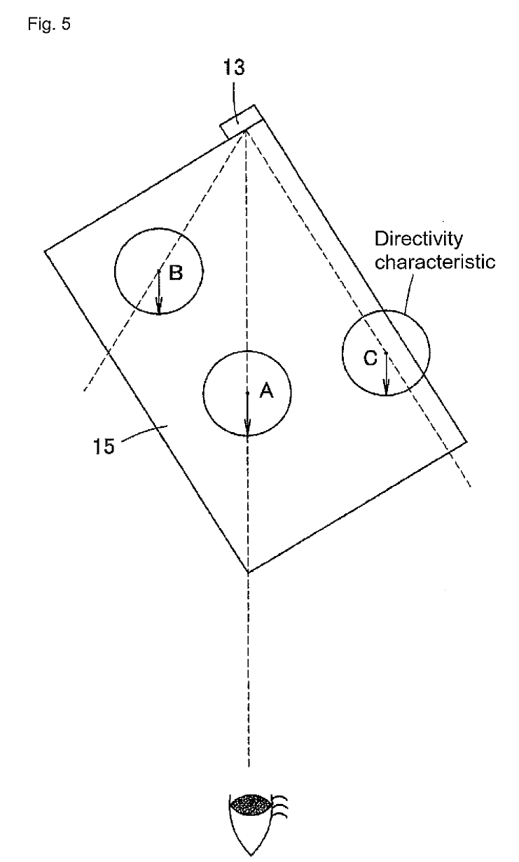

### DESCRIPTION OF SYMBOLS

31 Surface light source apparatus
32 Light guide plate
33 Light emission unit
35 Diffuser plate
36 Prism sheet
37 Uneven diffuser plate
38 Correcting optical sheet
39 Deflection pattern
41 Arcuate prism
42 First uneven pattern
43 Second uneven pattern
44 Combined pattern
45 Light outputting surface
46, 46A to 46E Correction pattern
61 Surface light source apparatus
62 Diffusion pattern

### BEST MODE FOR CARRYING OUT THE INVENTION

Embodiments of the present invention will be described in detail below with reference to the drawings. It should be noted that the present invention is not limited to the following embodiments.

### First Embodiment

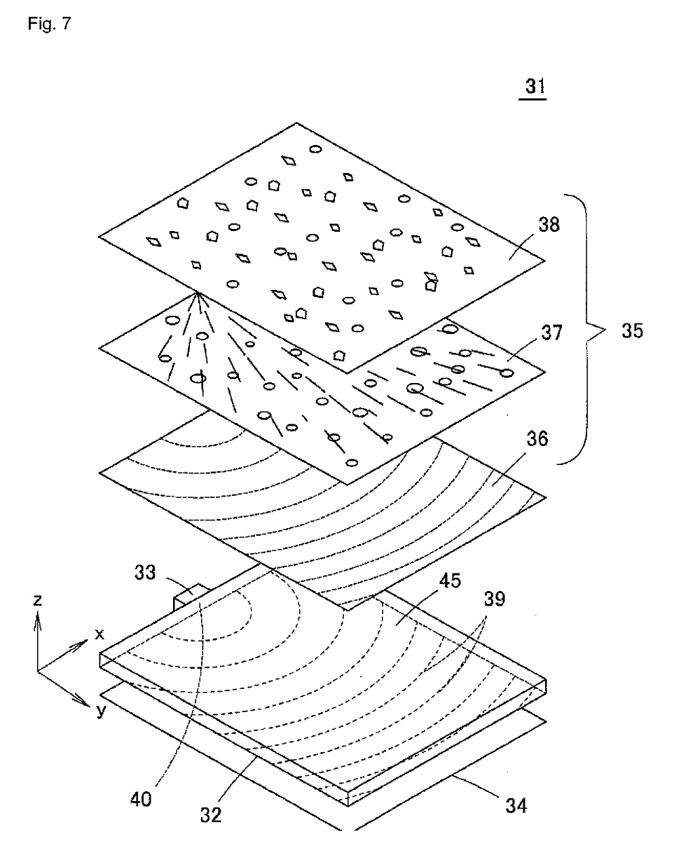

FIG. 7 is an exploded perspective view showing a surface light source apparatus 31 using a diffuser plate according to a first embodiment of the present invention. The surface light source apparatus 31 is configured by a light guide plate 32, a light emission unit 33, a reflecting plate 34, and a diffuser plate 35. The diffuser plate 35 is actually one optical sheet, but is shown divided to a prism sheet 36, an uneven diffuser plate 37, and a correcting optical sheet 38 according to functions in FIG. 7. In the description of the embodiment of the present invention, a z axis is defined in a direction perpendicular to the surface of the light guide plate 32, a y axis is defined in a direction perpendicular to one side (light incident surface 40), and an x axis is defined in a direction parallel to the one side. A radial direction having the light emission unit 33 as the center is defined as an r axis direction, and a direction perpendicular to the z axis and the r axis is defined as a θ axis direction.

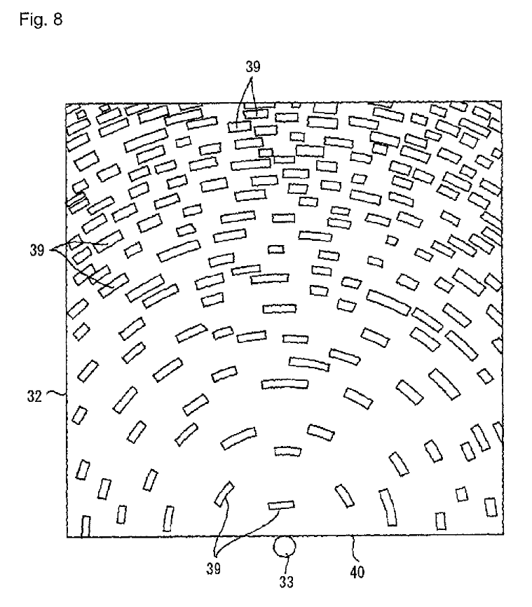

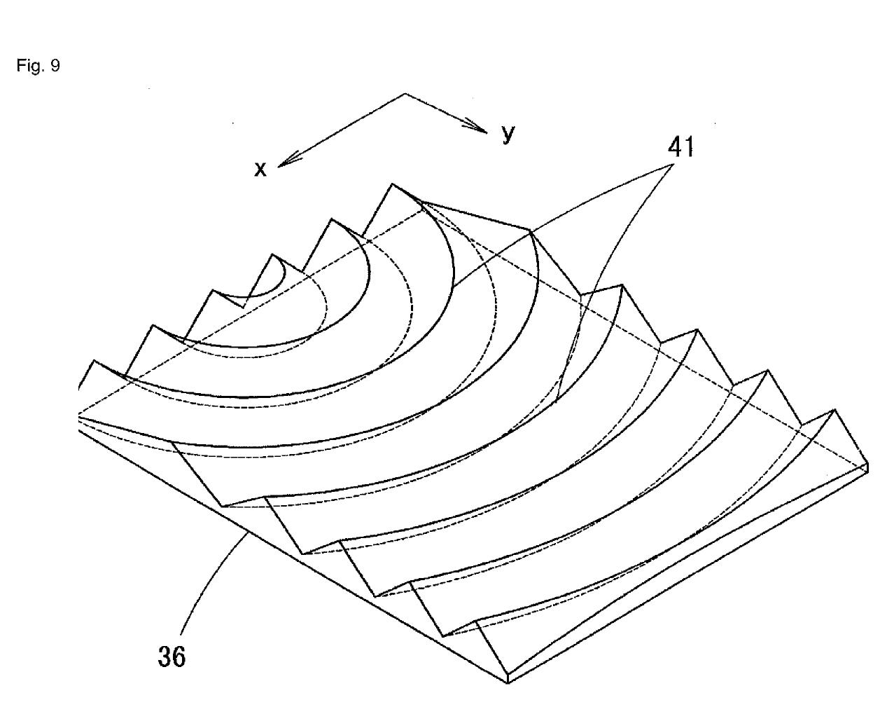

The light guide plate 12 is formed to a square flat plate shape from transparent resin such as polycarbonate resin and methacrylic resin, plural or great number of deflection patterns 39 are formed on the back surface. The array of deflection patterns 39 formed on the light guide plate 32 is shown in FIG. 8.

The deflection patterns 39 formed on the lower surface of the light guide plate 32 is arrayed on a concentric arc with the light emission unit 33 (particularly, internal LED) as a center, where each deflection pattern 39 is formed to a linear form by having the back surface of the light guide plate 32 to a concave shape with an asymmetric triangular cross-section. The angle of inclination of the inclined surface on the side close to the light emission unit 33 of the deflection pattern 39 having a triangular cross-section is desirably within 20°. Each deflection pattern 39 linearly extends along the circumferential direction of the arc having the light emission unit 33 as the center, and the reflecting surface of each deflection pattern 39 is orthogonal to a direction (r axis direction) connecting the light emission unit 33 and the relevant deflection pattern 39 in plan view (when seen from the z axis direction). The deflection pattern 39 is formed such that the pattern density gradually becomes greater the farther away from the light emission unit 33. However, the pattern density of the deflection pattern 39 may be substantially even in the vicinity of the light emission unit 33. An optical element including lens, prism and the like may be formed at a location facing the light emission unit 33 of the light incident surface 40 of the light guide plate 32 to control the orientation pattern of the light entering the light guide plate 32 from the light emission unit 33.

The light emission unit 33 is a point light source that emits light in substantially radial direction, and has one or a plurality of LEDs sealed in a transparent mold resin and the surface other than the front surface of the mold resin covered with white resin, although not shown. The light output from the LED is output from the front surface of the light emission unit 33 directly or after being reflected at a boundary of the mold resin and the white resin. In this embodiment, the light emission unit 33 is arranged at a position facing the middle part of the light incident surface 40 of the light guide plate 32, but may be arranged at the corner of the light guide plate 32. In this case, the arrangement of the deflection patterns 39 of the light guide plate 32 and each pattern of the diffuser prism sheet also need to be changed accordingly.

The reflecting plate 34 has the surface subjected to mirror-like finishing by Ag plating, and is arranged to face the entire back surface of the light guide plate 32.

The diffuser plate 35 has a transparent prism sheet 36 formed on the back surface of a transparent substrate (plastic sheet), and has a combined pattern in which the transparent uneven diffuser plate 37 and a correcting optical sheet 38 are superimposed formed on the surface of the transparent substrate. The prism sheet 36 is formed by dropping ultraviolet curable resin on the back surface of the transparent substrate, pressing the ultraviolet curable resin with a stamper to spread the ultraviolet curable resin between the stamper and the transparent substrate, and curing the ultraviolet curable resin by irradiating ultraviolet light (2P method: Photo Polymerization method). Similarly, the combined pattern of the uneven diffuser plate 37 and the correcting optical sheet 38 is also formed through the 2P method.

The prism sheet 36, the uneven diffuser plate 37, and the correcting optical sheet 38 are actually integrally formed, but will be separately described to facilitate the understanding. The prism sheet 36, the uneven diffuser plate 37, and the correcting optical sheet 38 may be partially or entirely formed as separate bodies from each other.

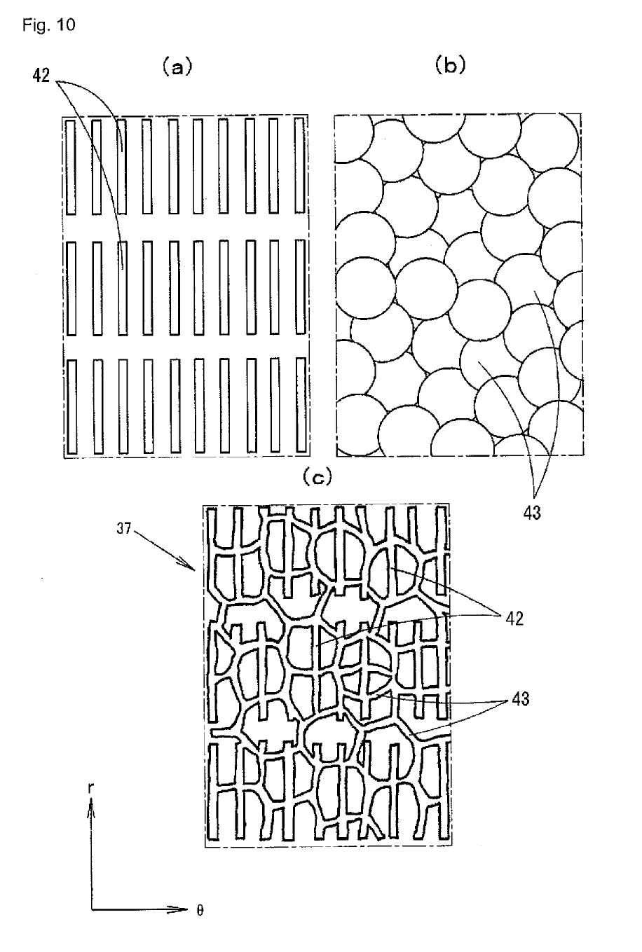

FIG. 9 is a perspective view seen from the back surface side showing a structure of the prism sheet 36. The prism sheet 36 has a concentrically arrayed arcuate prism 41 (in FIG. 9, the arcuate prism 41 is drawn to a large scale in an exaggerated manner), which cross-section has a left-right asymmetric triangular shape, where each arcuate prism 41 is formed to an arc shape with a position to be arranged with the LED of the light emission unit 33 as a center.

The uneven diffuser plate 37 is described in detail in Patent Document 2, and thus will only be briefly described herein. The uneven diffuser plate 37 has a first uneven shape and a second uneven shape molded all at once on the upper surface of the transparent substrate by a stamper etc., and the first uneven shape and the second uneven shape are placed one over the other so as to be combined. FIGS. 10(a) and (b) are views respectively showing one part of the first uneven shape and the second uneven shape, which are the basis of the combined pattern, and FIG. 10(c) is a view showing one part of the pattern formed on the surface of the uneven diffuser plate 37 based on the pattern combining the first uneven shape and the second uneven shape.

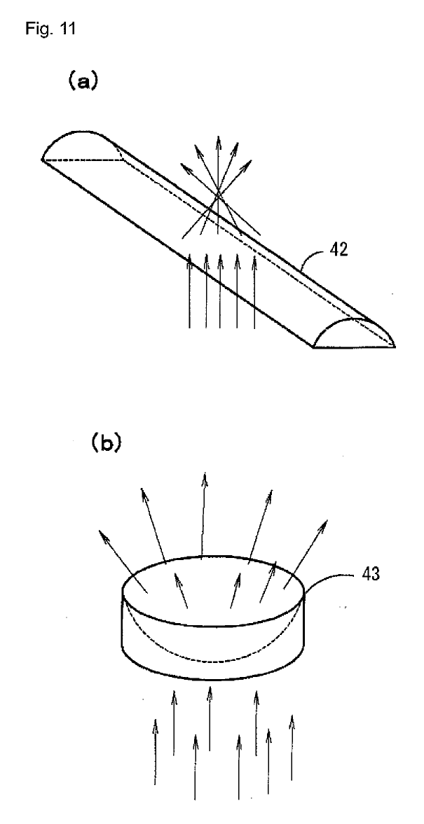

The first uneven shape is formed by a plurality of first uneven patterns 42 (concave part or convex part). The first uneven pattern 42 has the cross-section formed to a wave shape, a semicircular shape, a semi-elliptical shape, a cylindrical lens shape, a triangular prism shape, a cross-sectional trapezoid shape, and the like, and extends linearly with a uniform cross-section to a line form or a rod form. The first uneven pattern 42 is arrayed radially so that the length direction is parallel to the r axis direction. As shown in FIG. 11(a), the typical optical effect of the first uneven pattern 42 is to diffuse the incident light within a plane including an optical axis of the incident light (light beam of maximum luminosity) and being perpendicular in the length direction of the first uneven pattern 42 when the light perpendicularly enters from the lower surface side.

The second uneven shape is formed by a plurality of second uneven patterns 43 (concave part or convex part). The second uneven pattern 43 is formed to a spherical concave lens shape, an aspherical concave lens shape, a conical shape, a circular truncated cone shape, a pyramid shape, a truncated pyramid shape, and the like, and is arrayed randomly. The second uneven pattern 43 may also have a random size. Furthermore, the second uneven pattern 43 is desirably configured entirely by repeatedly and periodically arranging a basic pattern in which it is randomly arrayed. As shown in FIG. 11(b), the typical optical effect of the second uneven pattern 43 is to diffuse the incident light about a line parallel to the optical axis of the incident light and passing through a center of the second uneven pattern 43 when the light perpendicularly enters from the lower surface side.

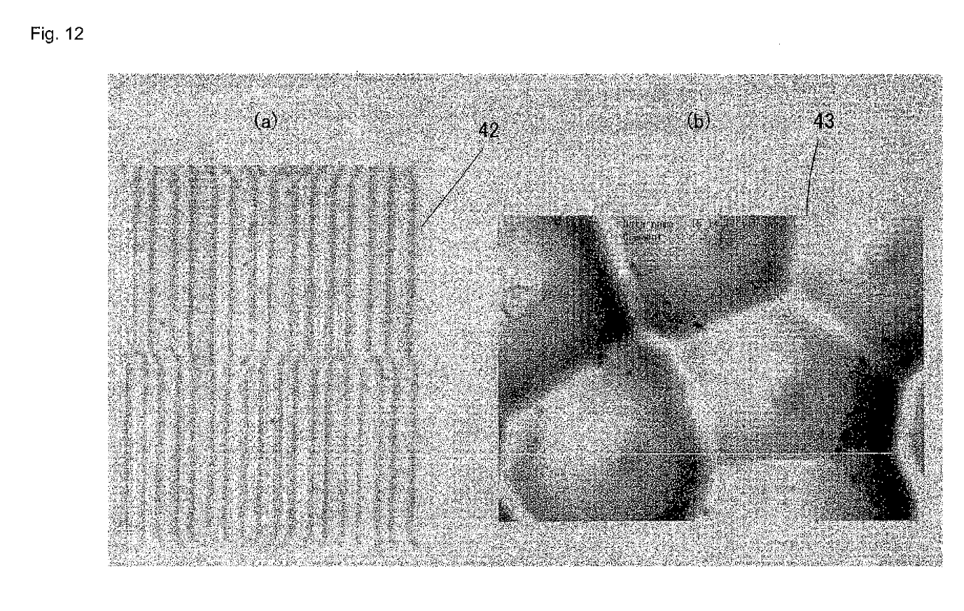

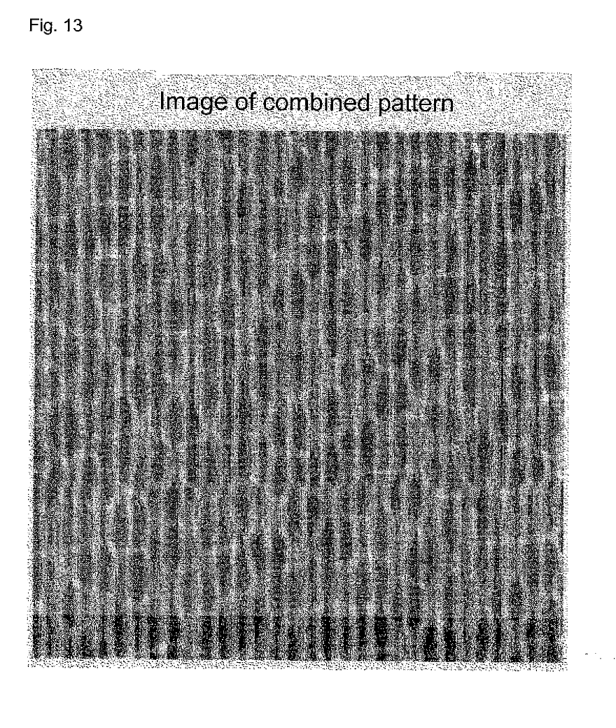

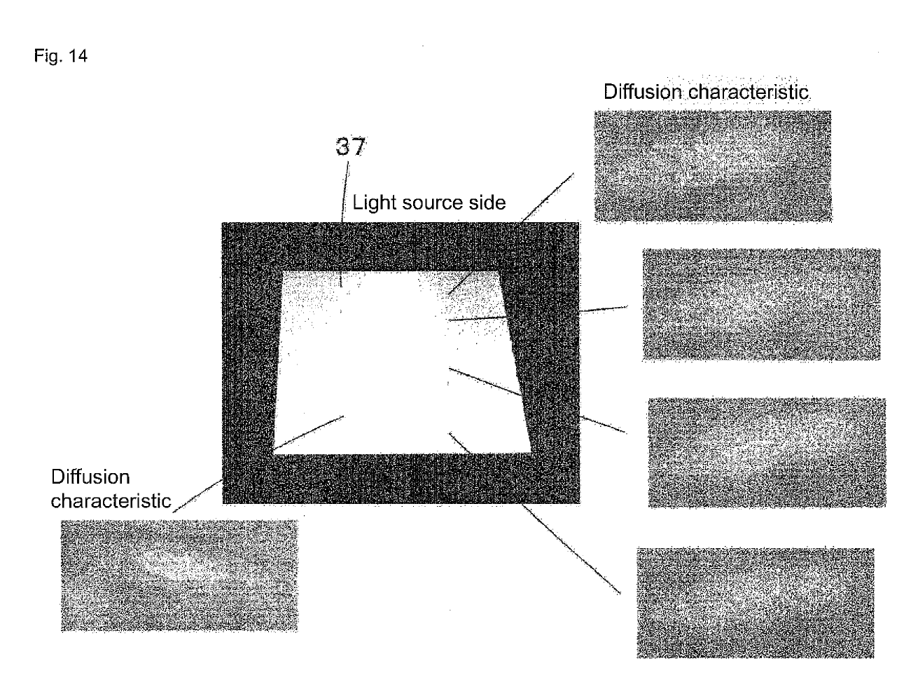

The combined pattern 44 of the uneven diffuser plate 37 is combined by placing a plurality of first uneven pattern 42 arrayed as in FIG. 10(a) and a plurality of second uneven patterns 43 arrayed as in FIG. 10(b) one over the other. FIG. 12(a) is an enlarged view of the first uneven pattern 42, FIG. 12(b) is an enlarged view of the second uneven pattern 43, and FIG. 13 is an enlarged view of one part of the combined pattern 44. FIG. 14 is a view showing diffusion characteristics of a transmissive light at each point of the uneven diffuser plate 37 when parallel light is perpendicularly irradiated to the uneven diffuser plate 37.

As described in the prior art example (see FIG. 2), the light output from the light emission unit 33 and entered into the light guide plate 32 is guided through the light guide plate 32 by repeating total reflection between the surface and the back surface of the light guide plate 32. When the light guided through the light guide plate 32 is totally reflected at the deflection pattern 39, the totally reflected light heads towards a light outputting surface 45 of the light guide plate 32, and the light entered into the light outputting surface 45 at an angle of incidence smaller than a critical angle of total reflection is passed through the light outputting surface 45 and output towards a direction substantially parallel to the light outputting surface 45. The light output towards the direction parallel to the light outputting surface 45 is then passed through the prism sheet 36 so that the direction of light is bent, and output in a direction substantially perpendicular to the light outputting surface 45.

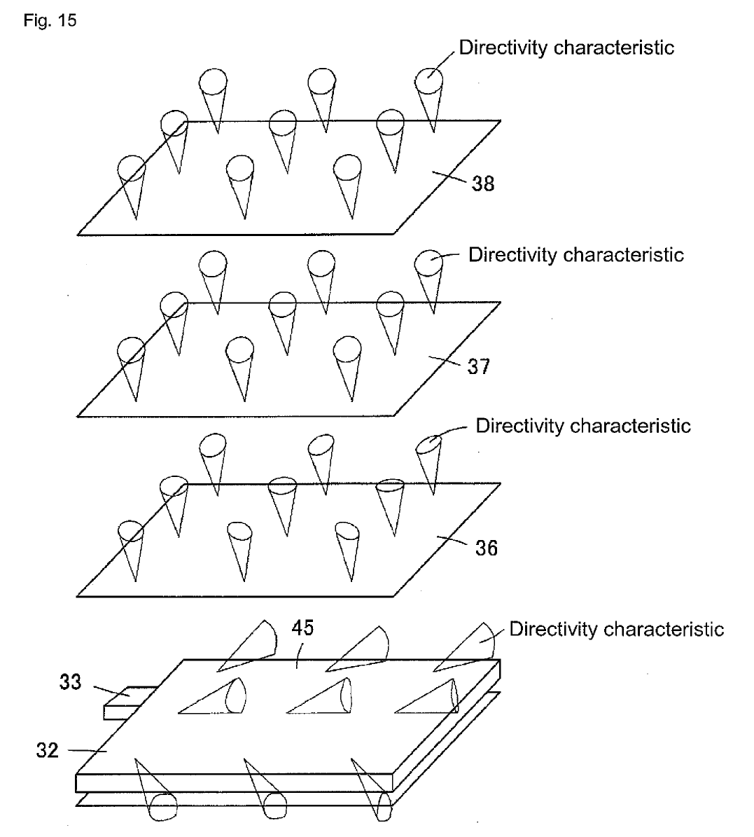

FIG. 15 is a view schematically showing the directivity characteristic of the light at each layer in a substantially conical shape. As apparent from the description of the prior art example, the directivity characteristic of light output from the light outputting surface 45 is wide in the up and down direction and narrow in the width direction. Thus, the directivity characteristic of the light passed through the prism sheet 36 is wide in the r axis direction and narrow in the θ axis direction. As apparent from FIG. 14, the diffusion characteristic of the uneven diffuser plate 37 is narrow in the r axis direction and wide in the θ axis direction. Therefore, the directivity characteristic of the light passed through the prism sheet 36 can be widened in the θ axis direction by further passing the light substantially perpendicularly passed through the prism sheet 36 through the uneven diffuser plate 37, whereby the spread in the r axis direction and the spread in the θ axis direction of the light passed through the uneven diffuser plate 37 become substantially equal, the directivity characteristics thereof become circular, and the bright lines and the luminance unevenness can be resolved.

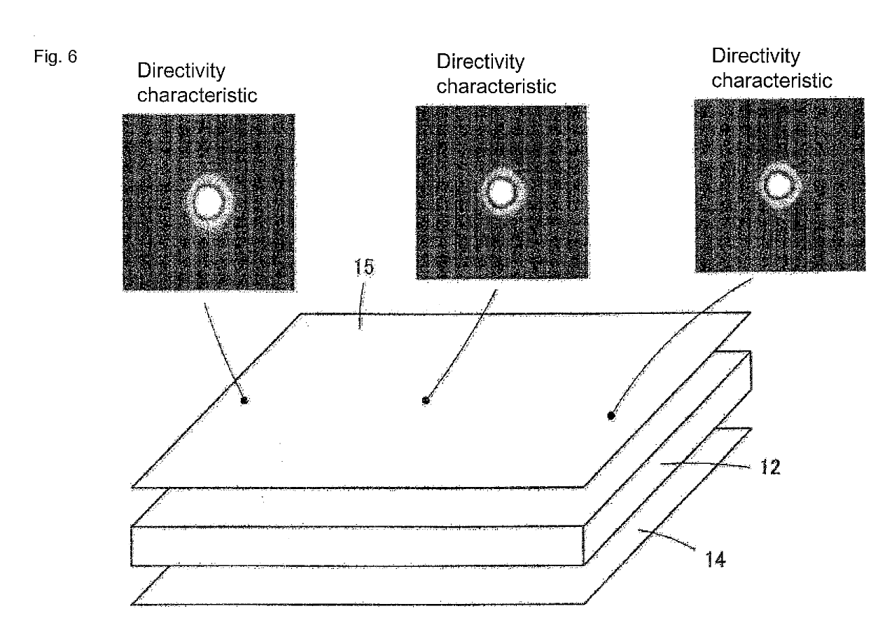

However, examining in detail the directivity characteristic of the light passed through the uneven diffuser plate 37, the directivity characteristic is slightly distorted to a spade shape, as described in FIG. 6 of the prior art example. The correcting optical sheet 38 is provided to further correct the slightly distorted directivity characteristic to obtain a directivity characteristic of a perfect circle. That is, the correcting optical sheet 38 merely needs to have a diffusion characteristic such that the directivity characteristic of the light passed therethrough becomes a perfect circle when the light having a directivity characteristic shown in FIG. 6 is passed through.

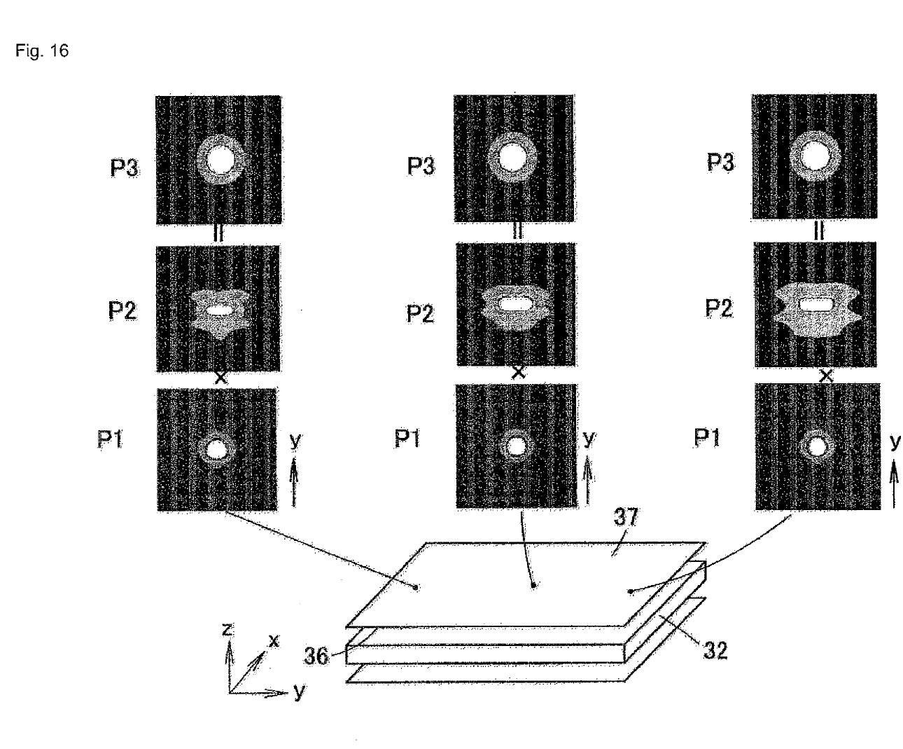

FIG. 16 shows a directivity characteristic P1 (same as shown in FIG. 6) of the light passed through the prism sheet 36 and the uneven diffuser plate 37, a directivity characteristic P3 of a target perfect circle (directivity characteristic P3 is substantially the same at any position), and a diffusion characteristic P2 for converting the light of directivity characteristic P1 to the light of directivity characteristic P3 at three points. The correcting optical sheet 38 can be fabricated by obtaining such diffusion characteristic P2 at the entire surface facing the light outputting surface 45. The diffusion characteristic P2 represents the light intensity in each direction of the light diffused by the correcting optical sheet 38 when the light perpendicularly enters the correcting optical sheet 38, and represents the characteristics seen from a direction perpendicular to the correcting optical sheet 38 in FIG. 16, FIG. 18, and the like.

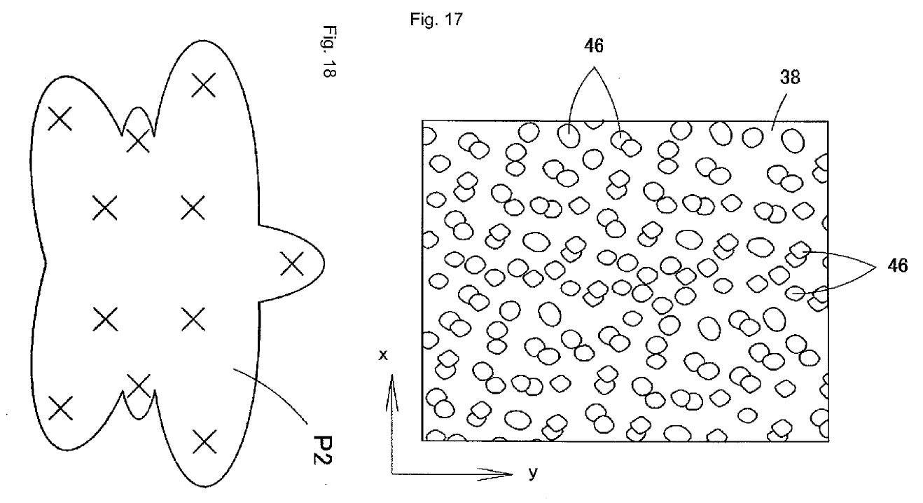

The directivity characteristic P3 may be the same at any position but the directivity characteristic P1 differs depending on the position, and thus the diffusion characteristic P2 to be obtained also differs depending on the position. Therefore, the shape of a correction pattern 46 of the correcting optical sheet 38 also needs to be individually designed one point at a time to realize the diffusion characteristic P2 at each position. However, obtaining the diffusion characteristic P2 corresponding to the directivity characteristic P1 in the entire correcting optical sheet 38 one point at a time is actually difficult, and becomes an extremely complicated surface shape (or correction pattern with complicated curved surfaces) in the correcting optical sheet 38. The pattern of the correcting optical sheet 38 is thus approximated by a distributed set of plural or great number of correction patterns 46 including polyhedrons having discrete diffusion characteristics, as shown in FIG. 17.

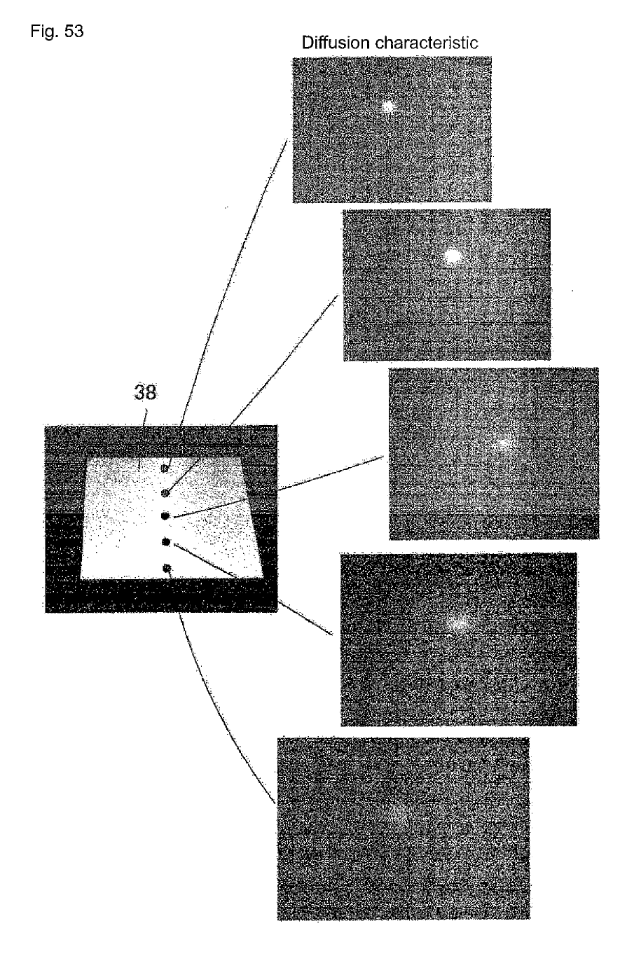

The result of obtaining the diffusion characteristic P2 at several places (only three points are shown in FIG. 16, but the diffusion characteristic P2 is obtained for multiple points) is observed, and the diffusion characteristic P2 of the correcting optical sheet 38 is found to have a pattern shown in FIG. 18. For instance, the diffusion characteristics of plural points are obtained over the entire correcting optical sheet 38, and are overlapped to obtain a general-purpose diffusion characteristic as shown in FIG. 18. The diffusion characteristics of individual points can be approximated at satisfactory precision by increasing or decreasing the relative luminance of each part shown in FIG. 18. Even if the diffusion characteristics of individual points appear to have a shape greatly differing from the diffusion characteristics of FIG. 18 (see FIG. 53), the luminance of one part of the diffusion characteristic of FIG. 18 can be assumed to be zero. Observing the diffusion characteristic of each point, the point (hereinafter, this point is referred to as a feature point. The feature point is represented with × mark in FIG. 18) that becomes a center of change in relative luminance can be defined by the position in the correcting optical sheet 38.

However, a complex polyhedron is obtained when obtaining the shape of the pattern having such diffusion characteristic P2, and designing and manufacturing of the correcting optical sheet 38 become difficult. The diffusion characteristic P2 shown in FIG. 18 is dissembled to a plurality of feature points, and the planes that can diffuse light to any one of the feature points are combined to assemble a plurality of types of polyhedrons having a discrete diffusion characteristic thereby determining the shape of the correction pattern 46.

Various shapes can be obtained for the shape of the correction pattern 46 depending on the manner of combining the feature points of FIG. 18. However, the polyhedron shape of the correction pattern 46 becomes simple or complicated depending on the manner of combining the feature points, and the necessary number of correction patterns 47 also differs. In this example, five polyhedron shapes are used for the correction pattern 46.

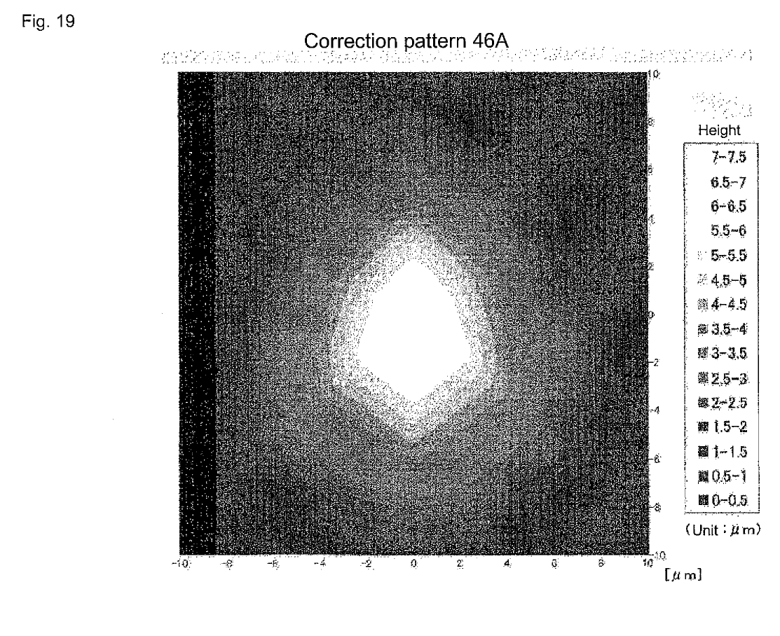

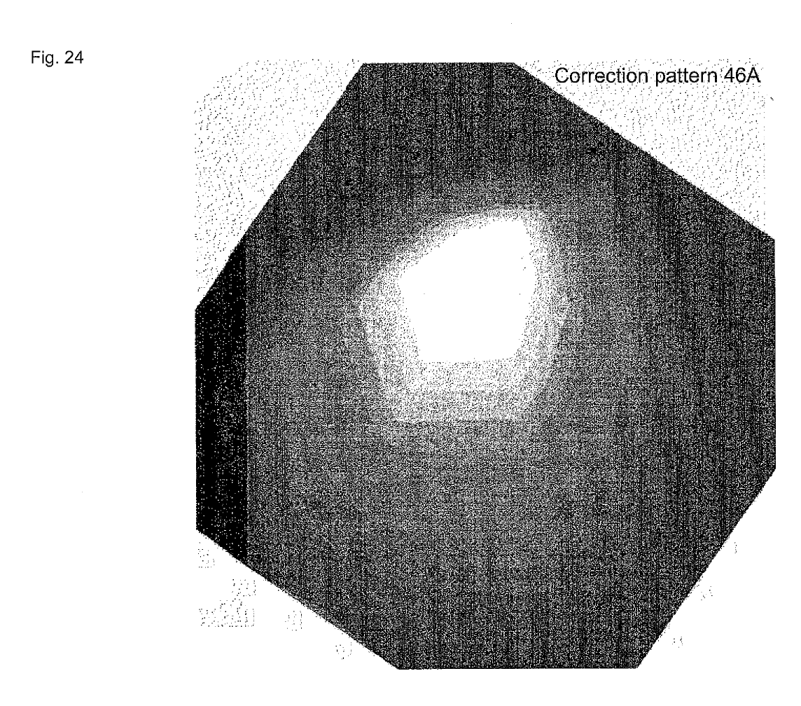

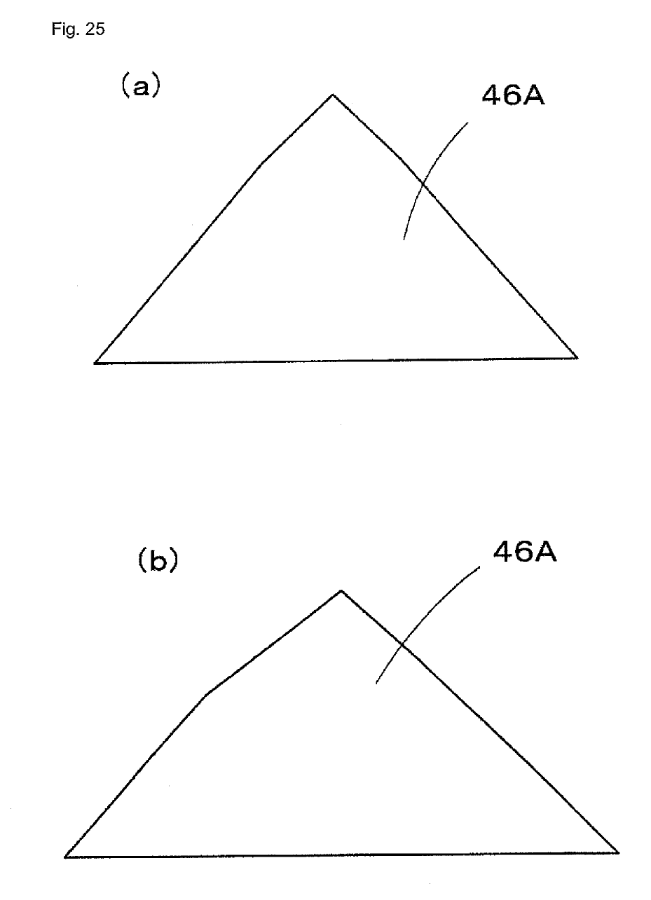

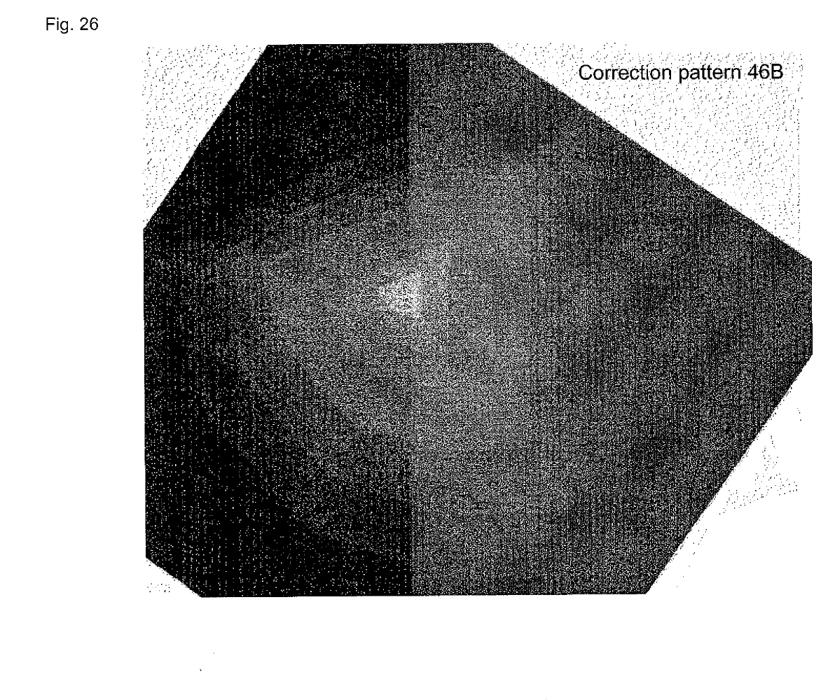

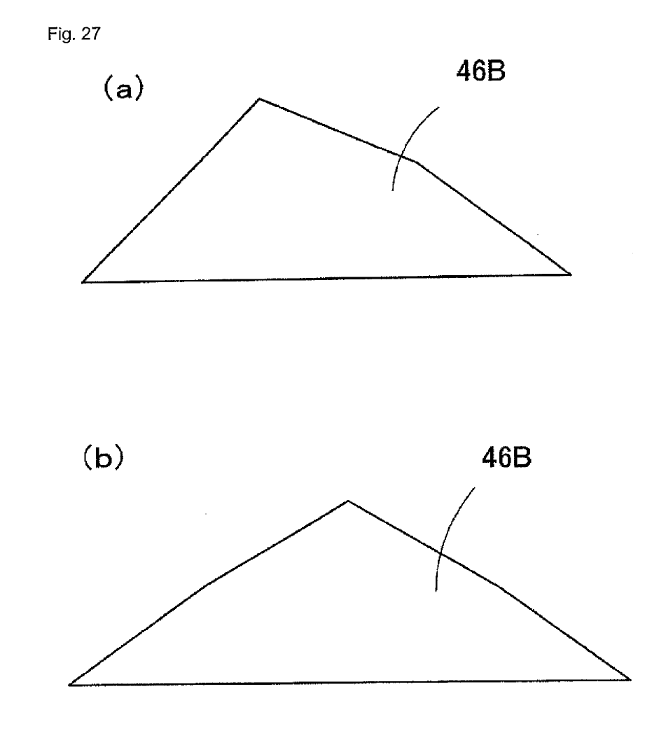

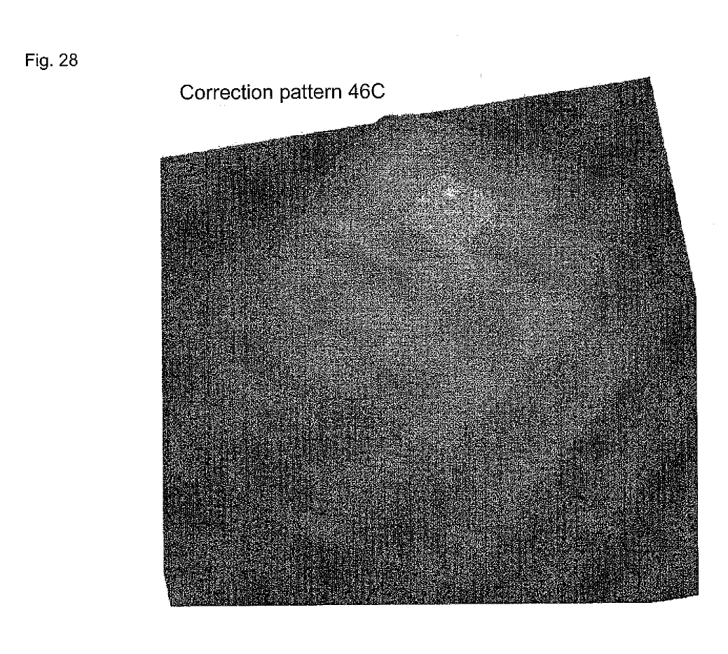

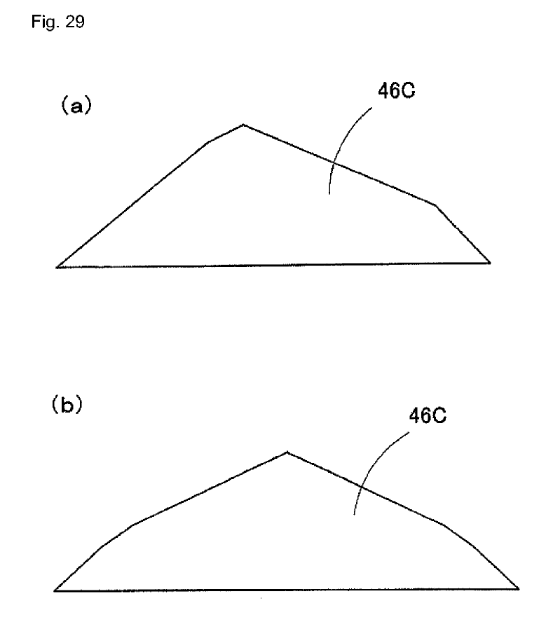

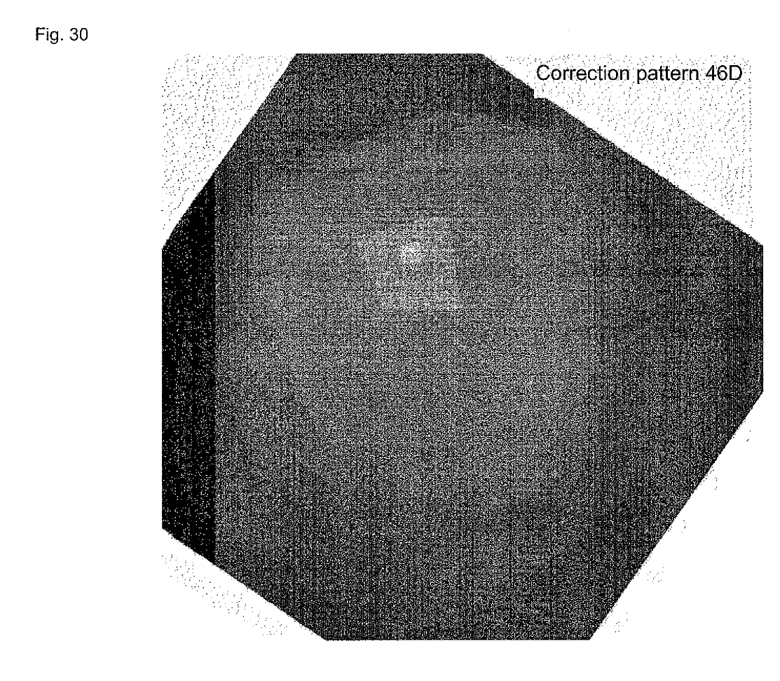

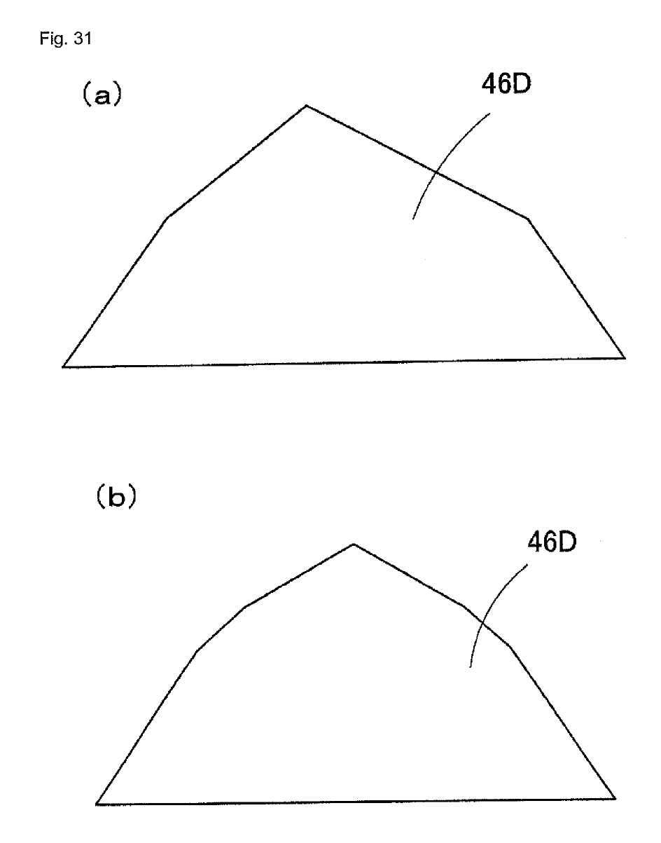

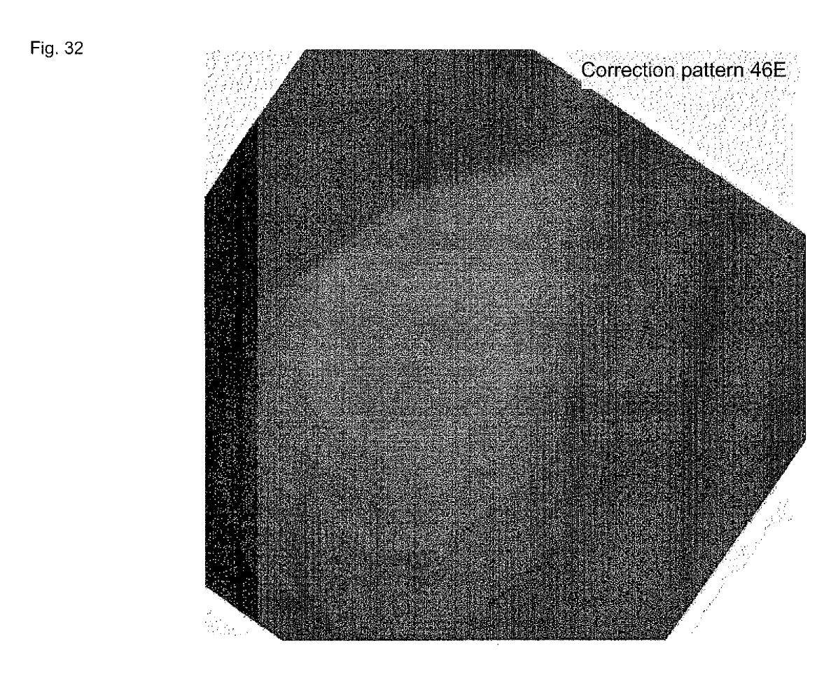

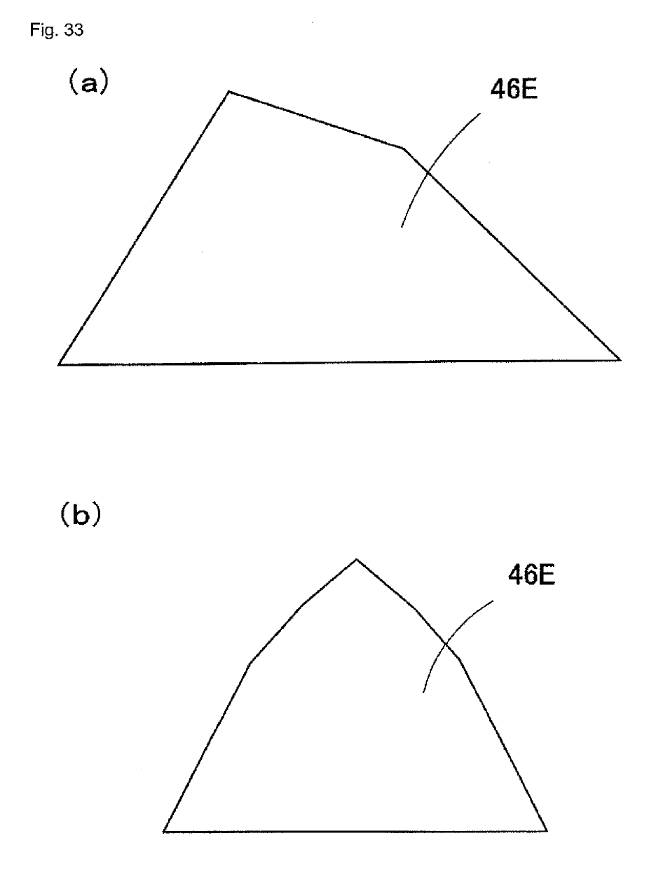

FIGS. 19 to 23 show a set of five patterns 46A to 46E in a contour map as one example of the correction pattern 46. FIG. 24 is a perspective view of the correction pattern 46A, and FIGS. 25(a) and (b) are views showing a contour of the correction pattern 46A seen from the front side and the side surface side. Similarly, FIG. 26 is a perspective view of the correction pattern 46B, and FIGS. 27(a) and (b) are views showing a contour of the correction pattern 46B seen from the front side and the side surface side. FIG. 28 is a perspective view of the correction pattern 46C, and FIGS. 29(a) and (b) are views showing a contour of the correction pattern 46C seen from the front side and the side surface side. FIG. 30 is a perspective view of the correction pattern 46D, and FIGS. 31(a) and (b) are views showing a contour of the correction pattern 46D seen from the front side and the side surface side. FIG. 32 is a perspective view of the correction pattern 46E, and FIGS. 33(a) and (b) are views showing a contour of the correction pattern 46E seen from the front side and the side surface side.

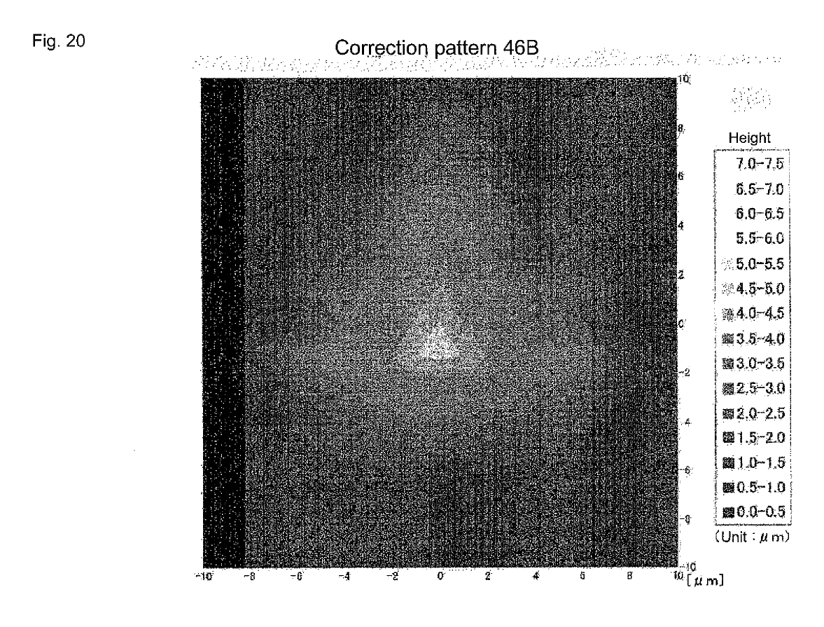

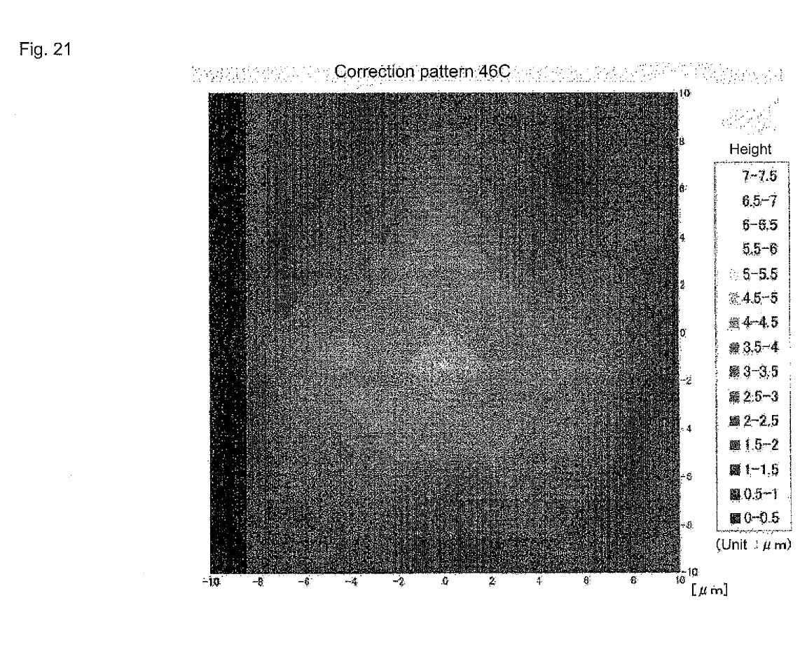

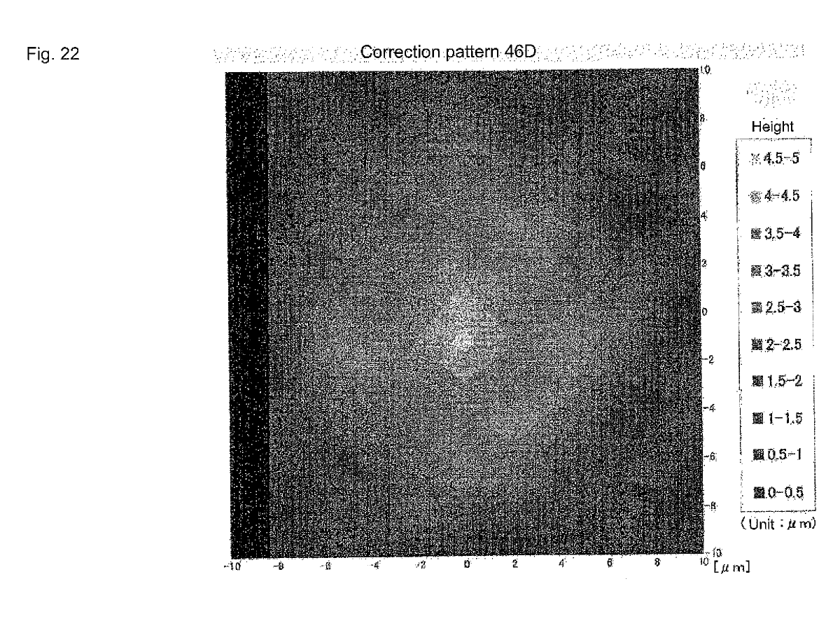

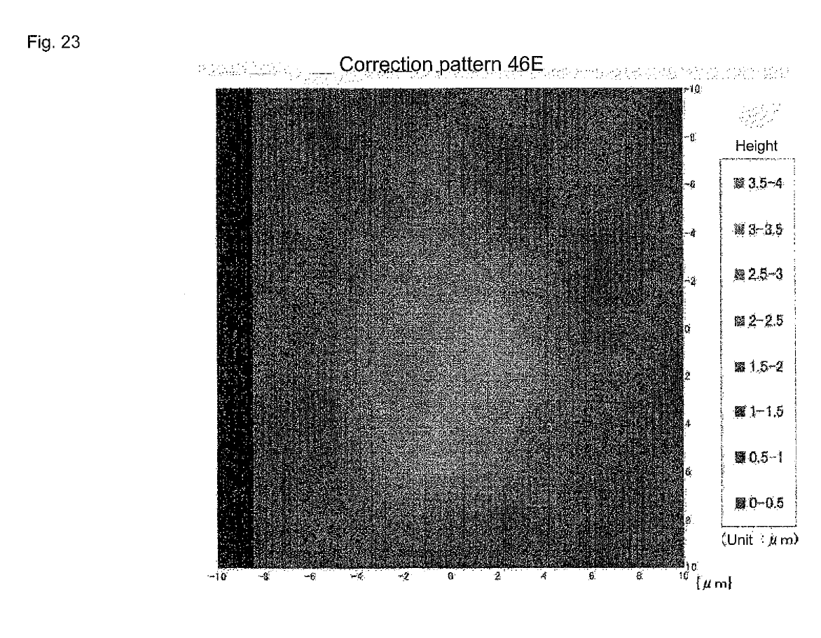

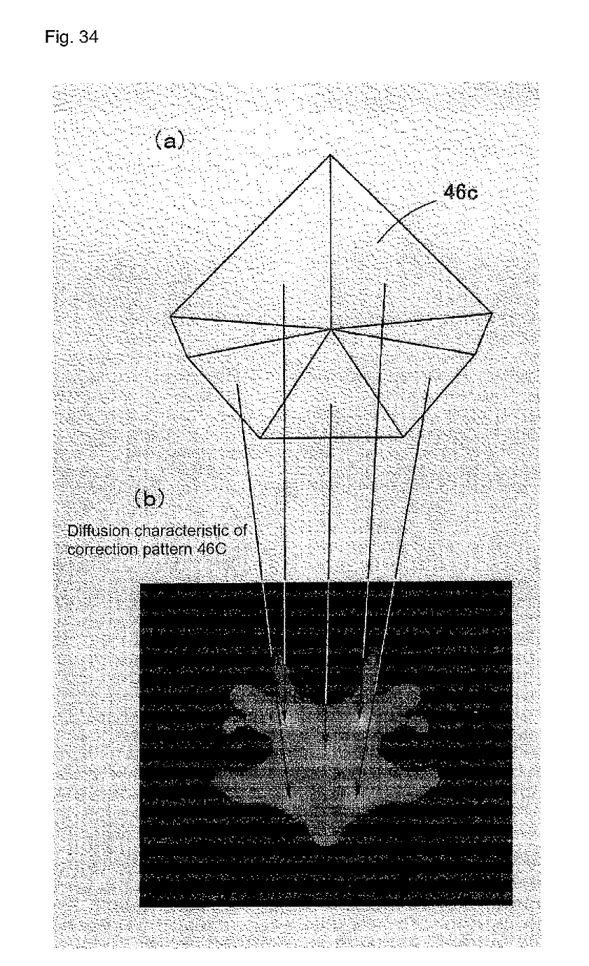

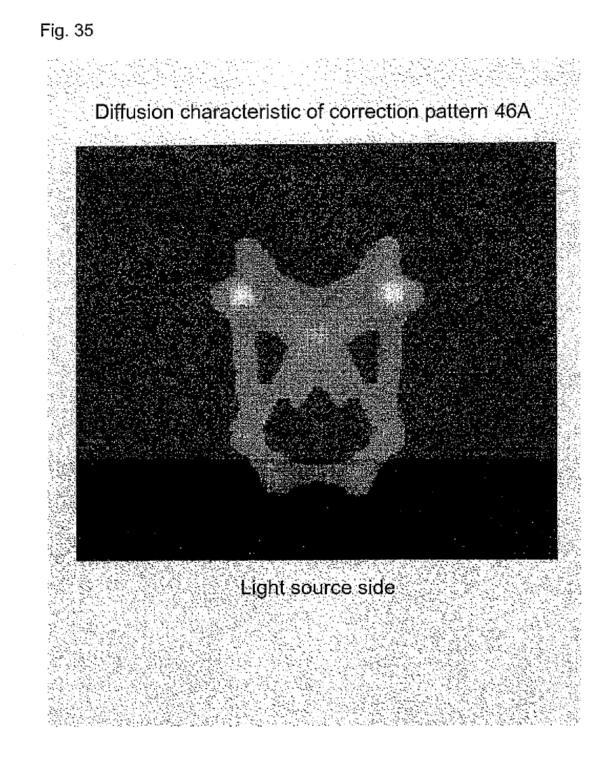

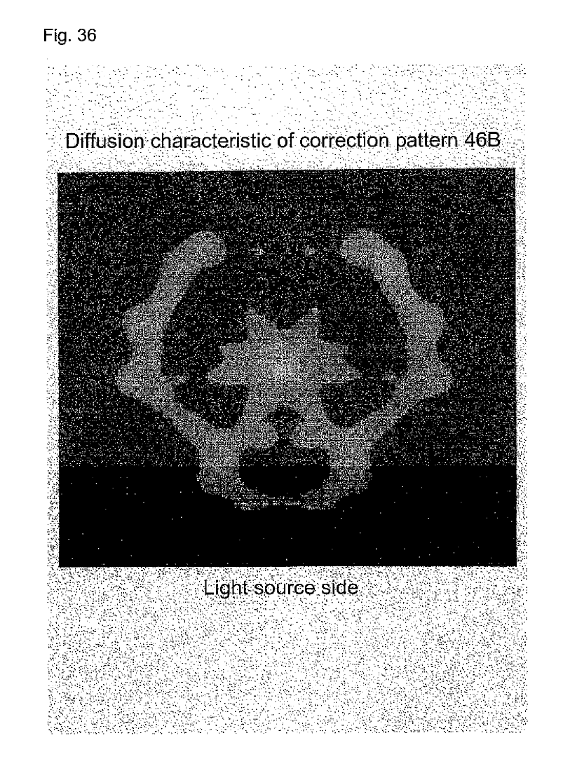

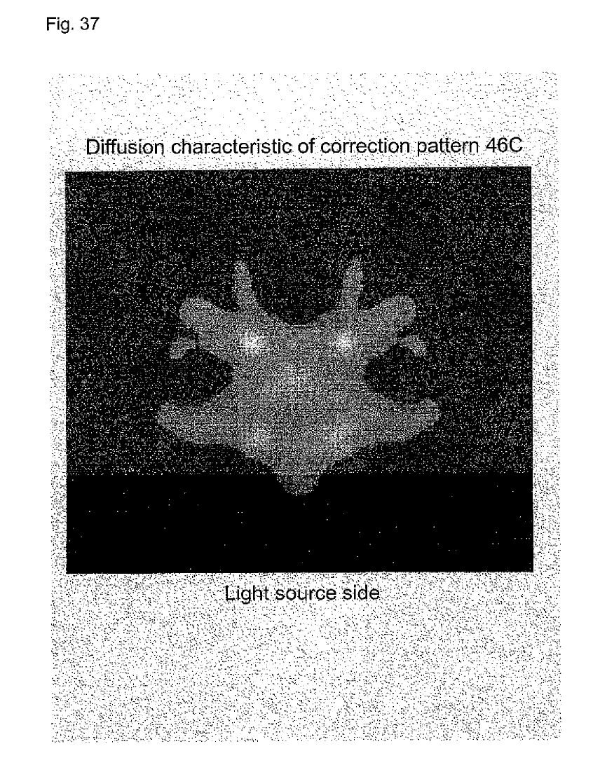

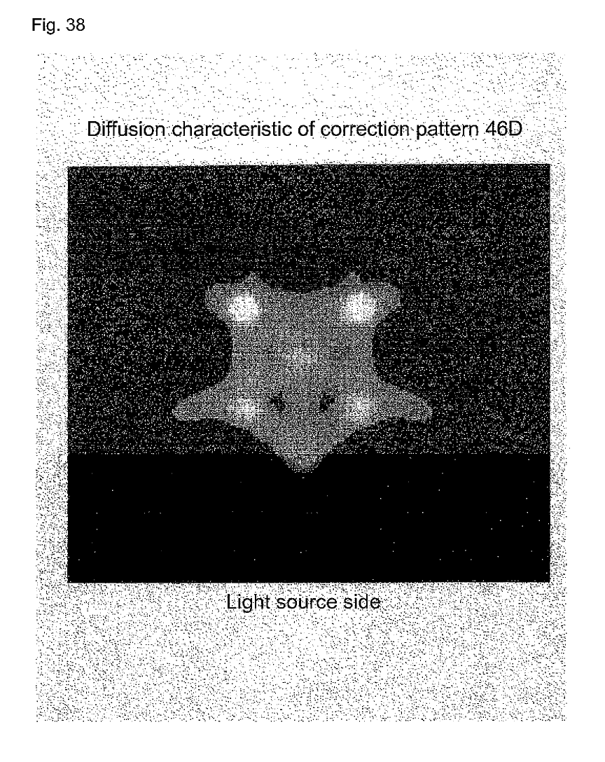

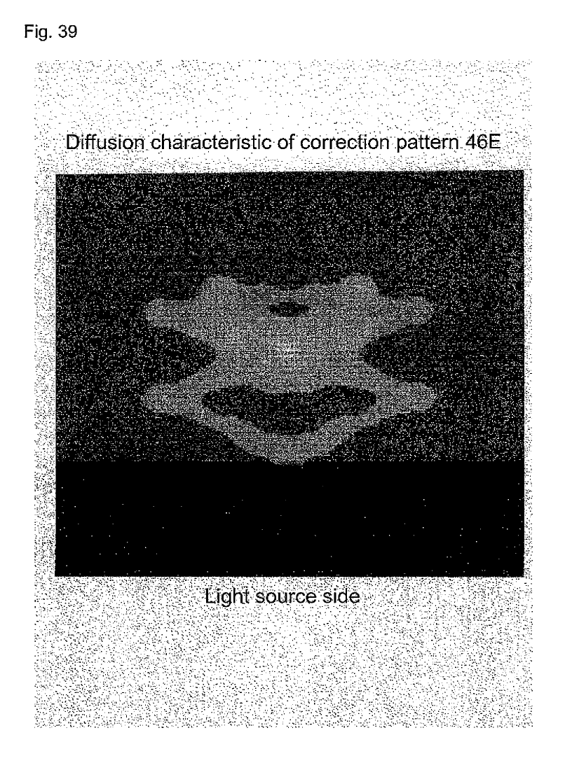

When a parallel light perpendicular to the correcting optical sheet 38 is entered to the correction patterns 46A to 46E, the light is refracted in each plane of the correction patterns 46A to 46E and output as a parallel light, and advances in the direction of the feature point. FIGS. 34(a) and (b) specifically describe this aspect using the correction pattern 46C by way of example. FIG. 34(a) is a schematic plan view schematically showing the main planes of the correction pattern 46C, and FIG. 34(b) is a view showing the diffusion characteristic of the light diffused by the correction pattern 46C. Among the parallel light perpendicularly entering the correcting optical sheet 38, the light passed through each plane of the correction pattern 46C shown in FIG. 34(a) is refracted at each plane, and output as a parallel light towards the direction of the feature point of FIG. 34(b) connected with arrows. The parallel light is refracted in different directions if the orientation and tilt (angle of inclination) of the planes configuring the polyhedron of the correction patterns 46A to 46E are different, and the luminance of the feature point changes if the area of the planes configuring the polyhedron are different. Therefore, the diffusion characteristic as shown in FIG. 35 can be obtained according to the correction pattern 46A as shown in FIG. 19. The diffusion characteristic as shown in FIG. 36 can be obtained according to the correction pattern 46B as shown in FIG. 20. The diffusion characteristic as shown in FIG. 37 can be obtained according to the correction pattern 46C as shown in FIG. 21. The diffusion characteristic as shown in FIG. 38 can be obtained according to the correction pattern 46D as shown in FIG. 22. The diffusion characteristic as shown in FIG. 39 can be obtained according to the correction pattern 46E as shown in FIG. 23.

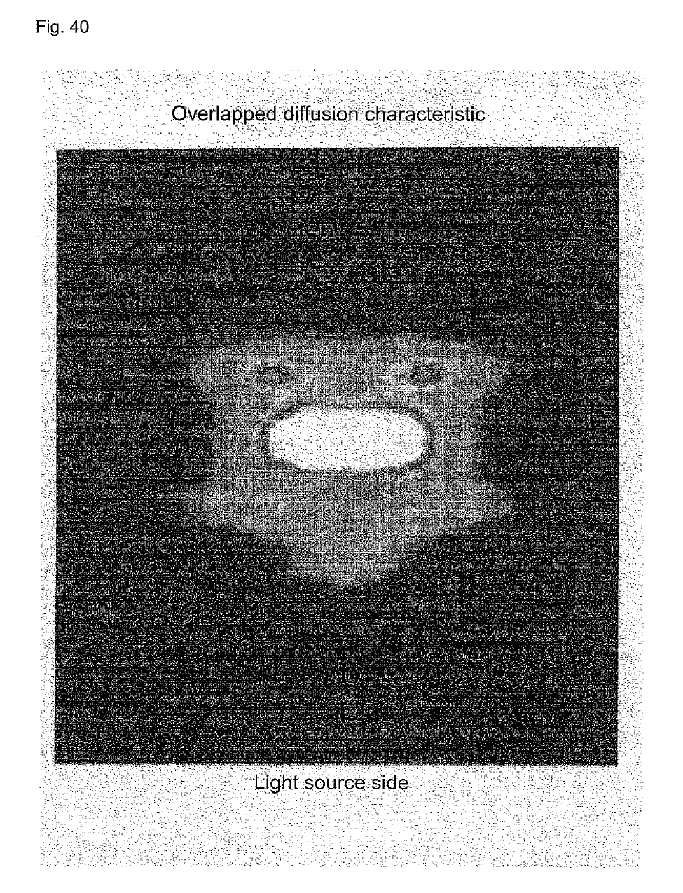

The target diffusion characteristic (FIG. 18) as in FIG. 40 can be realized by arranging the correction patterns 46A to 46 in a certain region and overlapping the diffusion characteristics (FIGS. 35 to 39) of the correction patterns 46A to 46E. Furthermore, the weight of overlapping of the diffusion patterns of FIGS. 35 to 39 can be changed and the relative luminance of the feature point can be adjusted individually by changing the distribution density of each correction pattern 46A to 46E, whereby an arbitrary diffusion characteristic at each point on the correcting optical sheet 38 can be obtained.

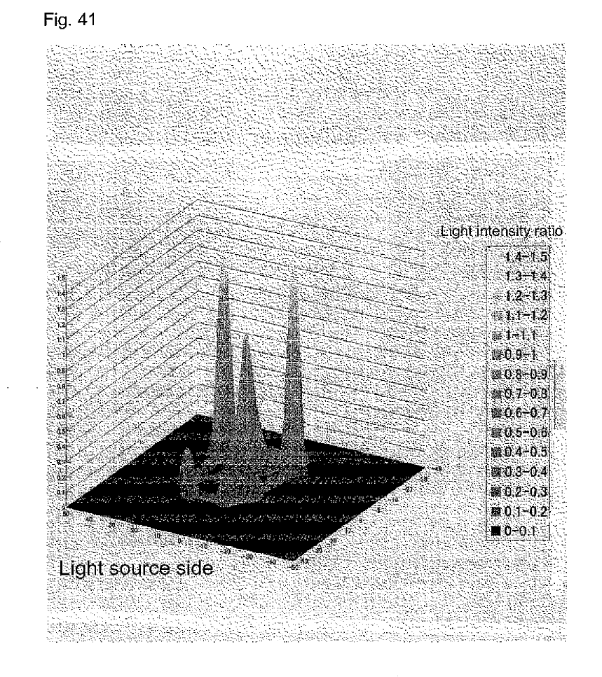

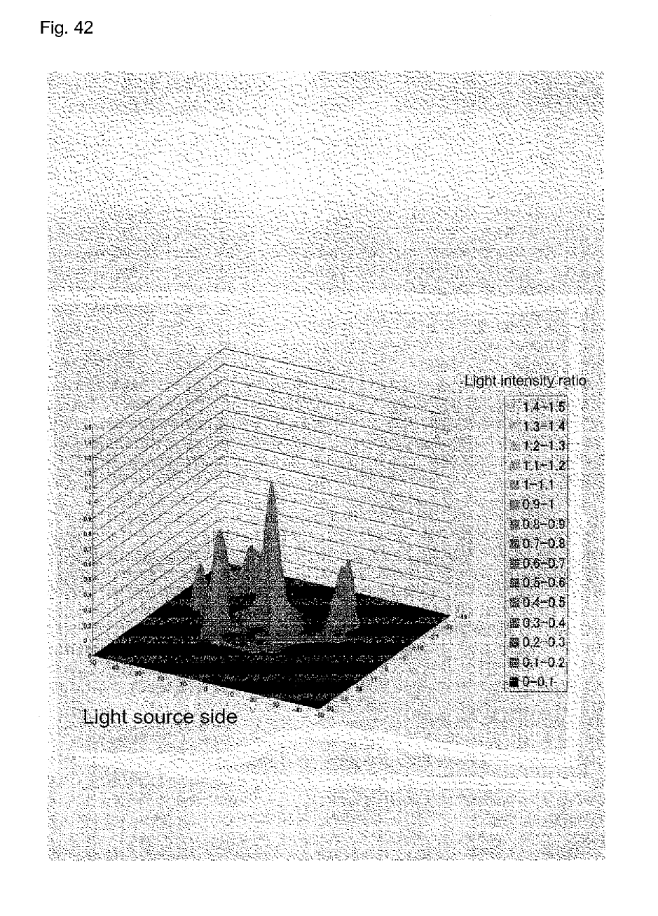

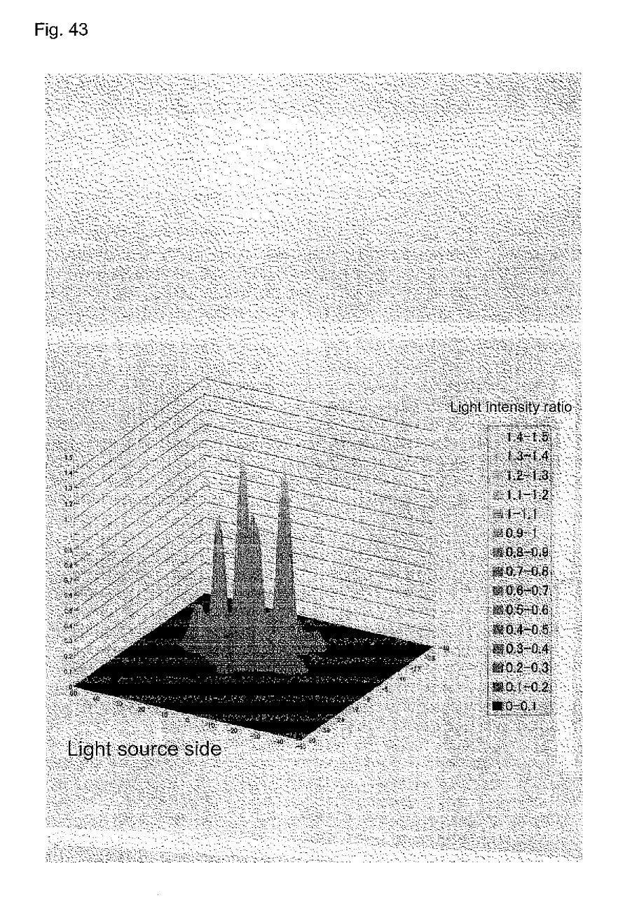

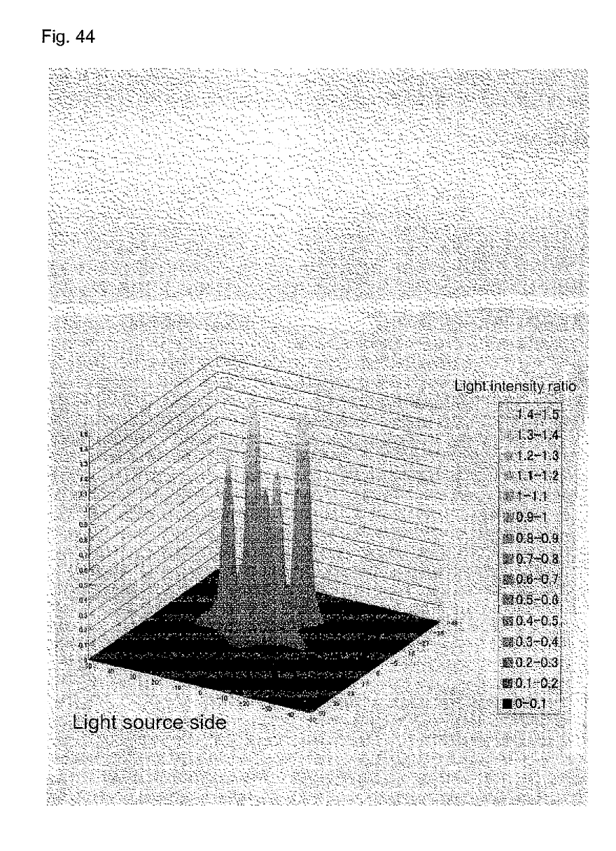

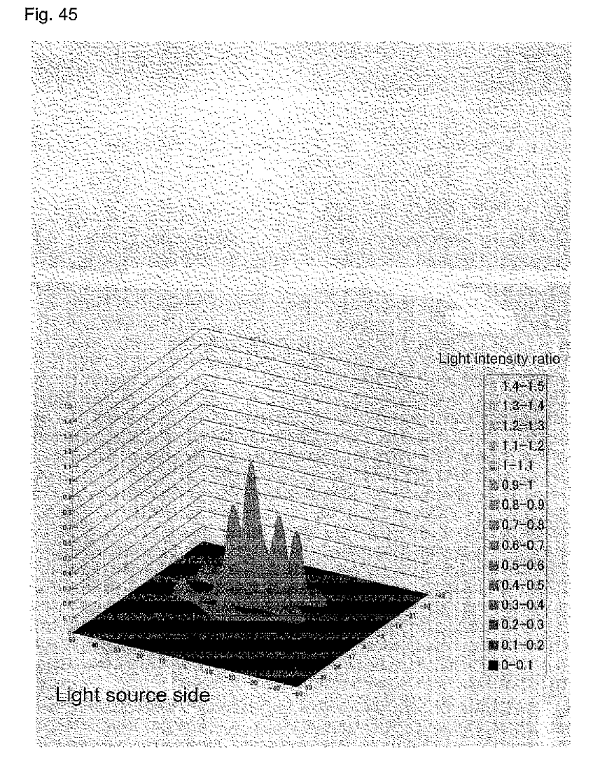

The correction patterns 46A to 46E have a discrete diffusion characteristic of outputting the light in a specific separated direction (feature point) as they are configured by a polyhedron defined by planes. FIGS. 41 to 45 are stereoscopic view of the diffusion characteristic of the correction patterns 46A to 46E, showing that the correction patterns have discrete diffusion characteristics, that is, the advancing direction of the output light and the distribution of intensity have a plurality of maximum values.

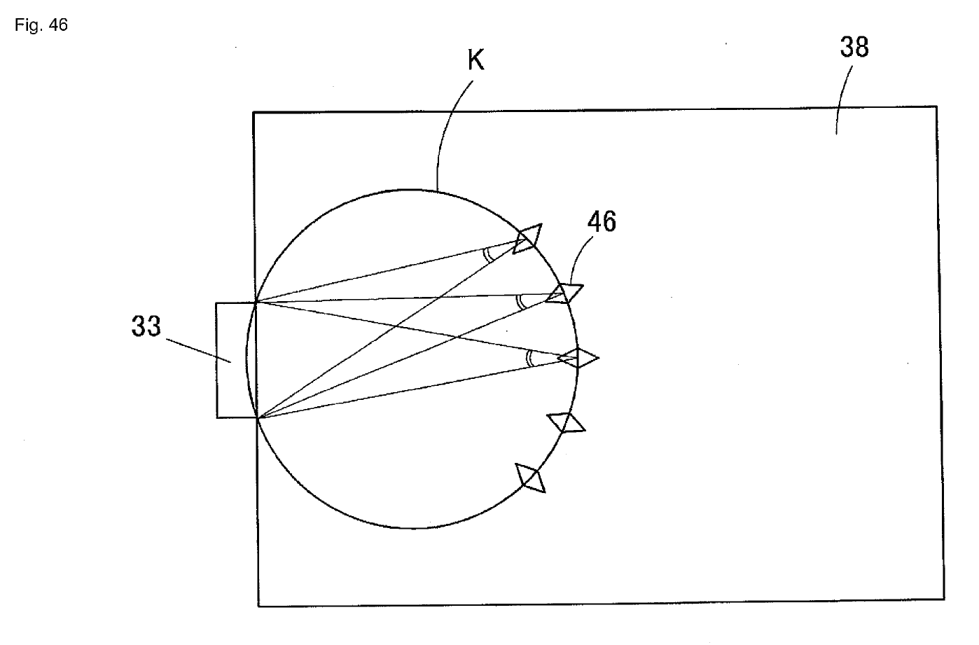

FIG. 46 shows location dependability of the correction pattern 46. Assuming a circle K passing through both ends of the light emission unit 33 when seen from the z axis direction, all the points on the circle K have the same spread of light entering from the light emission unit 33, and thus the directivity characteristic is assumed to be the same other than that the orientation is different. Thus, it is found that the same correction pattern 46 can be arranged while changing the orientation of the pattern along the circumference on the circle K passing through both ends of the light emission unit 33. The correction pattern 46 differs on circles having different radius, but for the sake of facilitating the design, the shape of the correction pattern 46 is not changed on different circles, and the pattern density of the correction pattern 46 is changed.

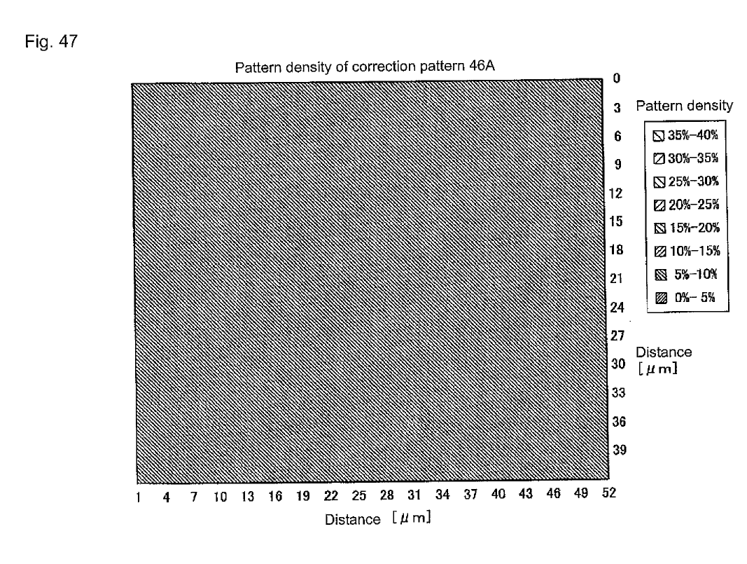

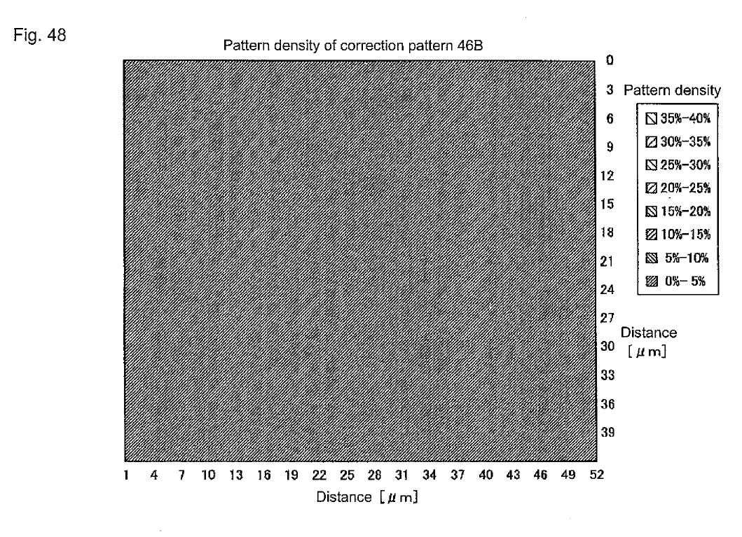

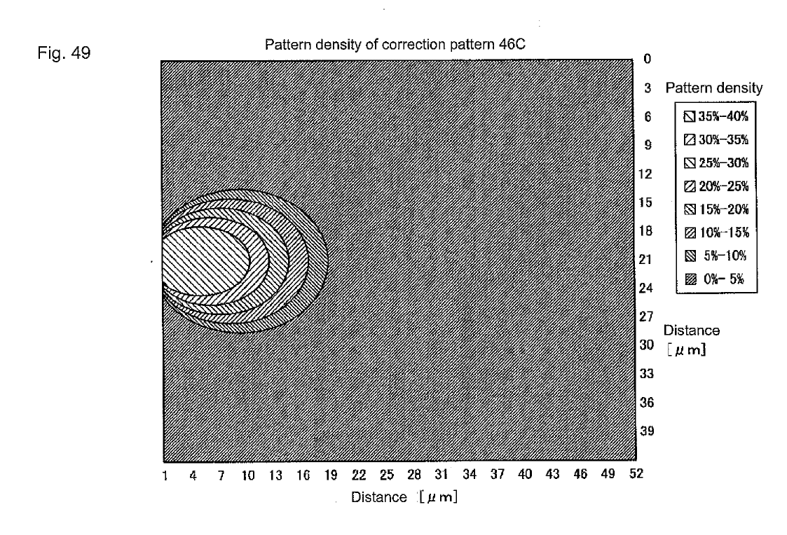

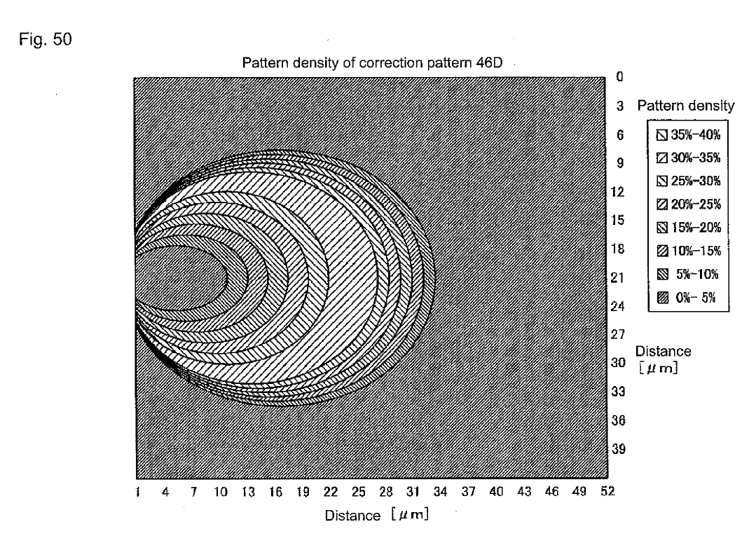

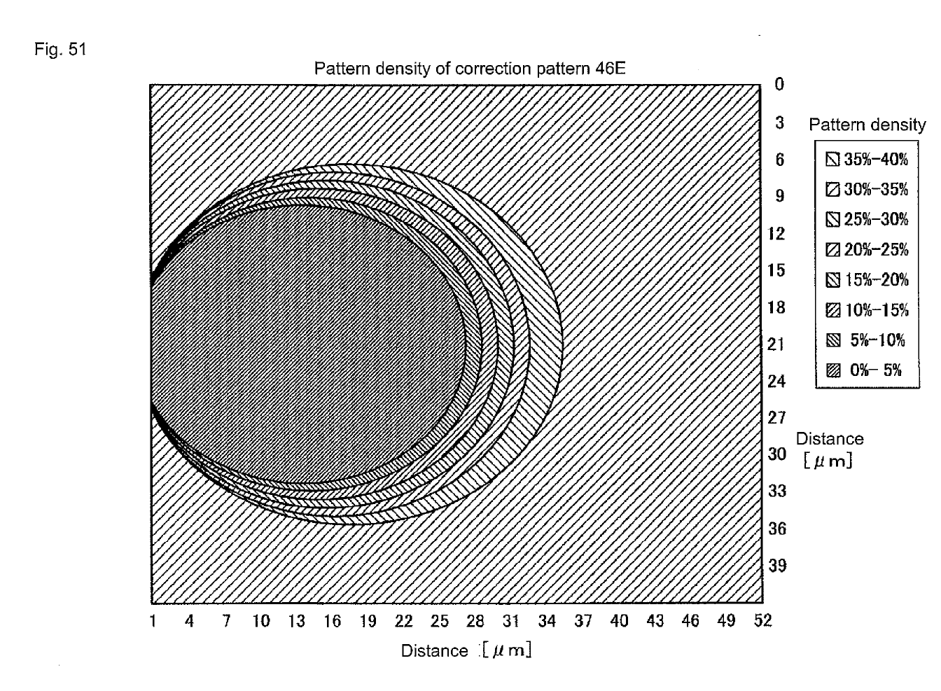

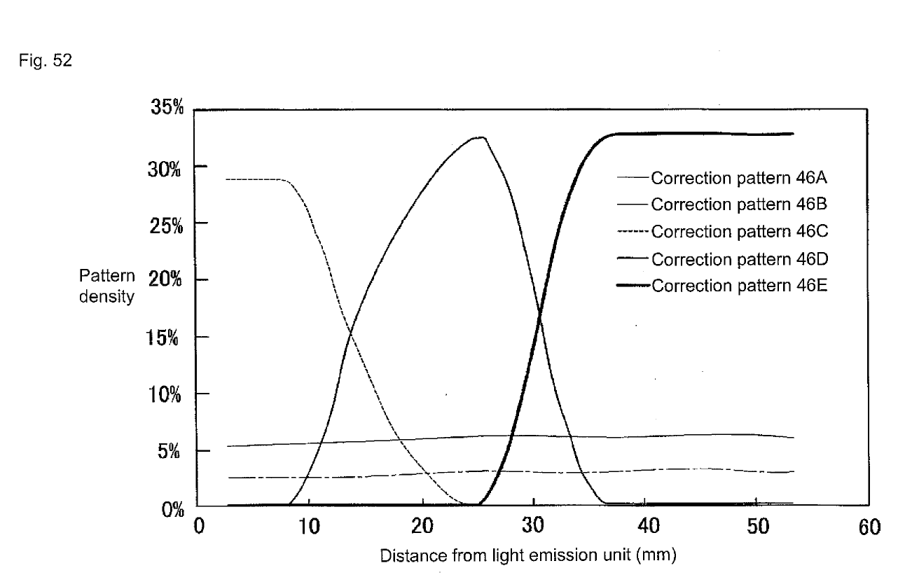

Therefore, the correction patterns 46A to 46E of FIGS. 19 to 23 are distributed on the correcting optical sheet 38 at a pattern density as shown in FIGS. 47 to 51. In FIGS. 47 to 51, the light emission unit 33 is positioned on the observer's left. FIG. 52 is a graph showing change in pattern density along the y axis direction at the middle of the surface light source apparatus 31 of each correction pattern 46A to 46E. The correction patterns 46A, 46B adjust the overall diffusion extent, and thus are evenly distributed over the entire correcting optical sheet 38. The correction pattern 46C has the pattern density increased at the vicinity of the light emission unit 33, the correction pattern 46E has the pattern density increased at a region distant from the light emission unit 33, and the correction pattern 46D has the pattern density increased at the intermediate region.

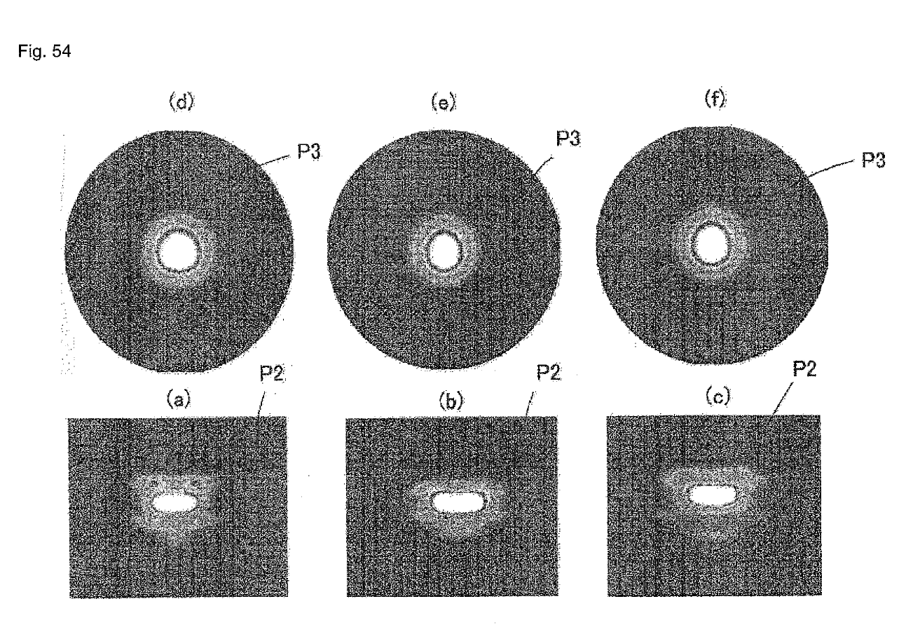

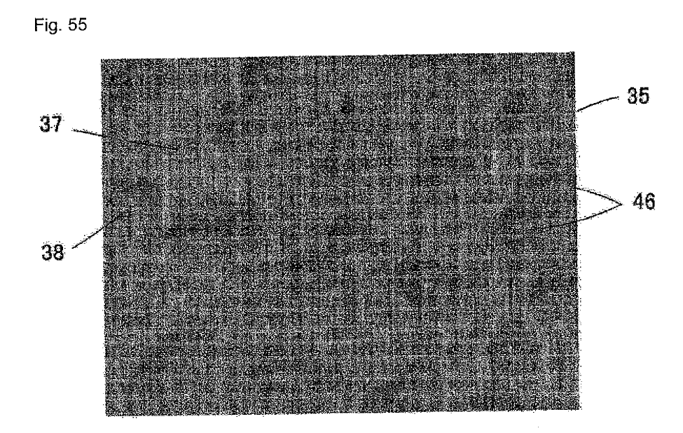

FIG. 53 shows the diffusion characteristic of the correcting optical sheet 38 obtained in the above manner. That is, when parallel light is irradiated to the correcting optical sheet 38 from the back surface side, the diffusion state of the light passed through the correcting optical sheet 38 is represented with five points at the middle of the correcting optical sheet 38. FIGS. 54(a) to (c) are views showing the diffusion characteristic P2 at appropriate points of the correcting optical sheet 38, and FIGS. 54(d) to (f) are views showing the directivity characteristic P3 of the light output from the surface light source apparatus 31 using the correcting optical sheet 38, where FIGS. 54(d) to (f) show the directivity characteristic P3 at each location having the diffusion characteristic P2 as shown in FIGS. 54(a) to (c). FIG. 55 is an enlarged view of one part of the surface of the diffuser plate 35.

When such correcting optical sheet 38 is used, the light output from the surface light source apparatus 31 will have a characteristic of a perfect circle as in the directivity characteristic P3 shown in FIGS. 54(d) to (f), and thus the bright lines and the luminance unevenness of the surface light source apparatus 31 are resolved.

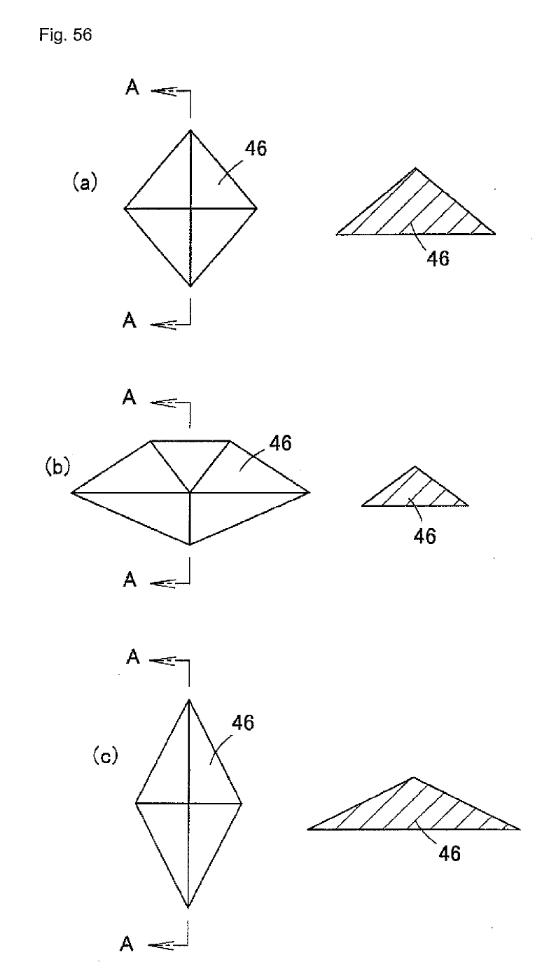

The correction pattern 46 takes various polygonal shapes depending on the manner of combining the feature points, and may also take shapes as shown in FIGS. 56(a) to (c) other than the correction pattern 46 of the shape as shown in FIGS. 19 to 23. In FIGS. 56(a) to (c), the view shown on the left side is a view showing a planar shape of the correction pattern 46, and the view shown on the right side is a cross-sectional view taken along line A-A of the left view. Each correction pattern 46 is basically a polyhedron defined by planes, but the vertex and the corner may be rounded, or it may be a polyhedron defined by gradual curved surfaces.

### Second Embodiment

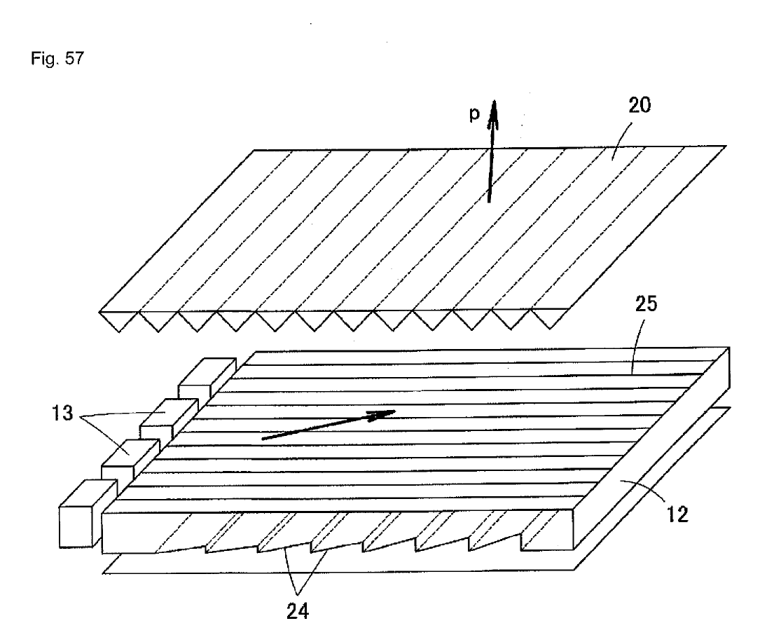

FIG. 57 is a perspective view showing another surface light source apparatus of the prior art. In such surface light source apparatus, the light emission unit 13 is formed to a linear light source by arraying a plurality of light emission units 13 facing the end face of the light guide plate 12. The deflection pattern 24 having a V-groove shape extending over the entire width in the width direction is arrayed in parallel on the back surface of the light guide plate 12, and the back surface of the light guide plate 12 is formed to a saw tooth-form. The deflection pattern 24 has a shallow angle, but the angle gradually becomes larger the farther away from the light emission unit 13. A diffusion pattern 25 of stripe-form extending in a direction perpendicular to the end face facing the light emission unit 13 is formed on the upper surface of the light guide plate 12. A prism sheet 20 is overlapped on the light guide plate 12.

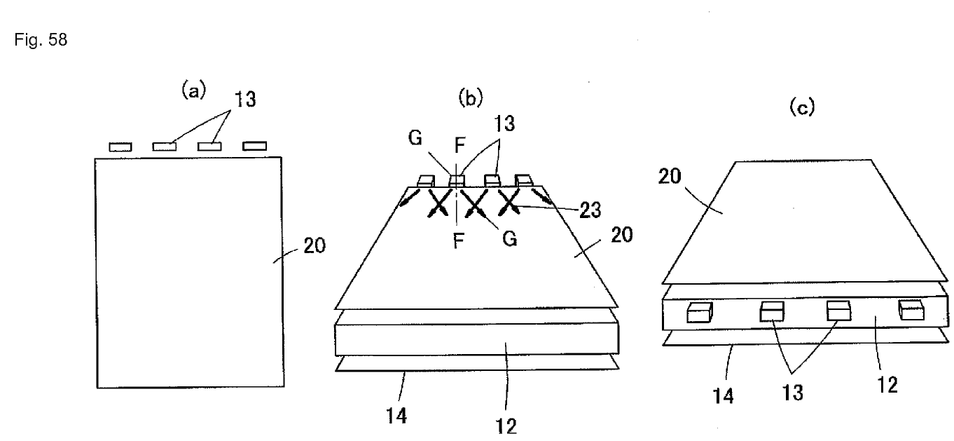

In the surface light source apparatus shown in FIG. 57, a uniform brightness is seen as shown in FIG. 58(a) when observed from the upper surface. However, when the surface light source apparatus is observed from diagonally above at 45° on the opposite side of the light emission unit 13, bright lines 23 are seen in the vicinity of the light emission unit 13, as shown in FIG. 58(b). On the other hand, when the surface light source apparatus is observed from diagonally above at 45° on the light emission unit 13 side, bright lines are not seen, as shown in FIG. 58(c).

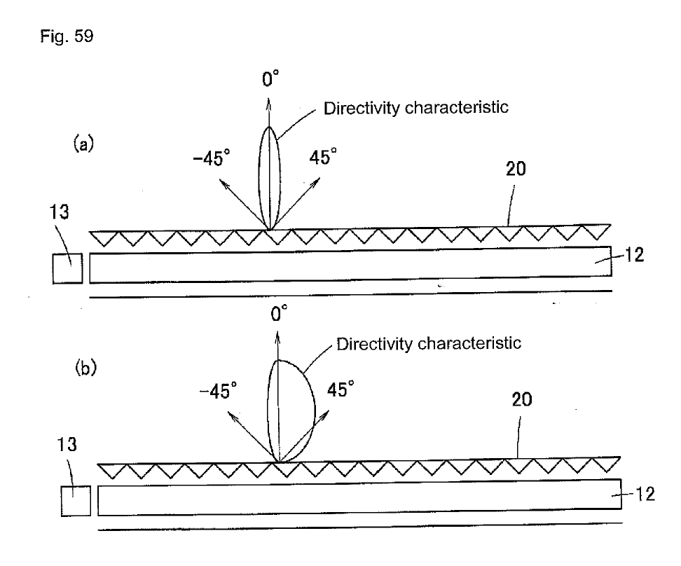

FIGS. 59(a) and (b) are views describing the reason why the bright lines are seen when viewed from the opposite side of the light emission unit 13. FIG. 59(a) shows the cross-section taken along line F-F of FIG. 58(b) and the directivity characteristic in the relevant direction, and FIG. 59(b) shows the cross-section taken along line G-G of FIG. 58(b) and the directivity characteristic in the relevant direction. The directivity characteristic as shown in FIG. 59(a) is obtained at the cross-section immediately in front of the light emission unit 13, and the directivity characteristic as shown in FIG. 59(b) is obtained in the diagonal direction of the light emission unit 13, where the directivity characteristic is projected to the side opposite to the light emission unit 13 in the diagonal direction. Thus, the bright lines 23 are seen when viewed from the opposite side of the light emission unit 13, but the bright lines are not seen when viewed from the light emission unit 13 side.

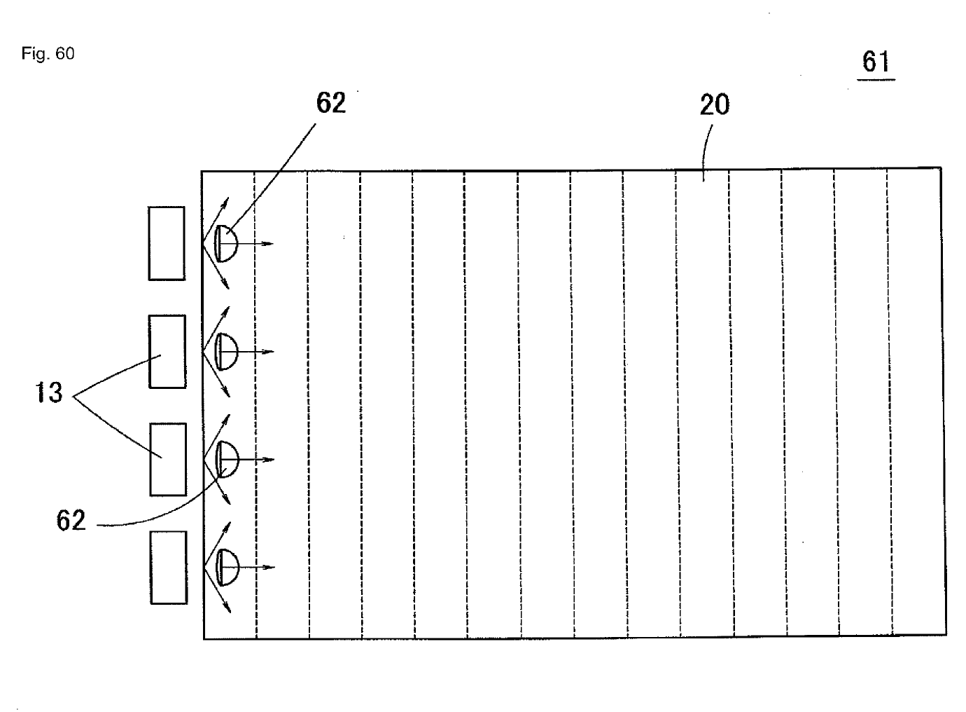

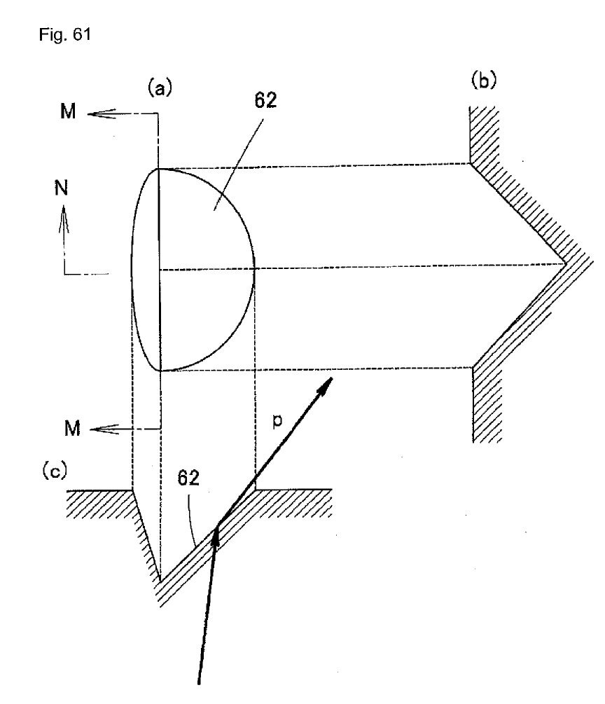

FIG. 60 is a plan view showing a surface light source apparatus 61 according to a second embodiment of the present invention. The surface light source apparatus 61 has a structure similar to the surface light source apparatus shown in FIG. 57 except that the diffusion pattern 62 is formed on the upper surface of the prism sheet 20. The diffusion pattern 62 is arranged immediately in front of each light emission unit 13 at the upper surface of the prism sheet 20. FIG. 61(a) is a plan view of the diffusion pattern 62, FIG. 61(b) is a cross-sectional view taken along line M-M of FIG. 61(a), and FIG. 61(c) is a cross-sectional view taken along line N-N of FIG. 61(a).

In the surface light source apparatus 61 of the present invention, since the diffusion pattern 62 is arranged immediately in front of the light emission unit 13, the light p perpendicularly passed through the prism at the lower surface of the prism sheet 20 passes through the diffusion pattern 62 immediately in front of the light emission unit 13 so as to be output in the direction of substantially 45° towards the opposite side of the light emission unit 13, as shown in FIG. 61(c). Thus, the light is output not only in the diagonal direction but also towards the front side, whereby bright lines are less likely to occur even when observed from the opposite side of the light emission unit 13.

Note that, in the second embodiment, the diffusion pattern 62 is arranged on the upper surface of the prism sheet 20, but the correcting optical sheet having the diffusion pattern 62 may be arranged so as to overlap the prism sheet 20.

1. The ornamental design for an AIRCRAFT LUGGAGE COMPARTMENT FRONT as shown and described.
